(19) United States
(12) Patent Application Publication
(10) Pub. No.: US 2023/0292753 A1
(43) Pub. Date: Sep. 21, 2023

(54) AN INSECTICIDAL COMPOSITION FOR PEST CONTROL COMPRISING OF DIACYLHYDRAZINES

(71) Applicant: RAJDHANI PETROCHEMICALS PRIVATE LIMITED, Gujarat (IN)

(72) Inventors: Dipakkumar PATEL, Ahmedabad, Gujarat (IN); Kenal V. SHAH, Ahmedabad, Gujarat (IN); Bhavesh V. SHAH, Ahmedabad, Gujarat (IN); Kawarlal DABHODIA, Ahmedabad, Gujarat (IN)

(21) Appl. No.: 18/015,388

(22) PCT Filed: Jul. 7, 2021
(86) PCT No.: PCT/IN2021/050658

§ 371 Date: Jan. 10, 2023

(30) Foreign Application Priority Data
Jul. 10, 2020 (IN) 202021029368

(51) Int. Cl. A01N 37/40; A01N 25/04; A01N 43/56; A01N 43/58; A01N 43/713; A01N 37/22; A01N 47/40; A01N 43/80; A01N 47/44; A01N 37/34; A01N 43/90

(52) U.S. Cl. CPC A01N 37/40; A01N 25/04; A01N 43/56; A01N 43/58; A01N 43/713; A01N 37/22; A01N 47/40; A01N 43/80; A01N 47/44; A01N 37/34; A01N 43/90

(57) ABSTRACT

An insecticidal composition for pest control comprising diacylhyrazines. More particularly the present invention related to a synergistic agrochemical insecticidal composition comprising of bioactive amount of at least one insecticide from diacylhydrazines group; at least one insecticide from diamide or a pyridylpyrazole group; and at least one insecticidal compound selected from Acephate, Profenofos, Fipronil, Bifenthrin, lambda-cyhalothrin, Clothiandin, Dinotefuran, Thiamethoxam, Pymetrozine, Spinetoram, Spinosad, Emamectin benzoate, Novaluron, Indoxacarb, Azadirechtin. The present invention further relates to process for preparing the said compositions in specific ratio. The present invention further relates to the process for preparing the said composition along with at least one inactive excipient; and formulations thereof. The present invention further relates to the synergistic insecticidal compositions, wherein active ingredient present in fixed ratio shows synergy in an insecticidal activity.

### FIELD OF THE INVENTION

The present invention relates to synergistic insecticidal compositions comprising bioactive amounts of (A) at least one insecticide from diacylhydrazines group; (B) at least one insecticide from diamide or a pyridylpyrazole group; (C) at least one insecticidal compound selected from Acephate, Profenofos, Fipronil, Nicofluprole, Bifenthrin, lambda-cyhalothrin, Clothiandin, Dinotefuran, Thiamethoxam, Spinetoram, Spinosad, Emamectin benzoate, Novaluron, Indoxacarb, Afidopyropen, Flonicamid, Pymetrozine, Triflumezopyrim, Azadirechtin, Oxazosulfyl, dimpropyridaz and tyclopyrazoflor. The present invention further relates to process of preparing said composition along with at least one inactive excipients and formulation thereof.

### BACKGROUND OF THE INVENTION

Combination of insecticides are used to broaden the spectrum of control of insect, to improve the pest control with synergistic effect, reduce dosage, thereby reducing environmental impact, to broaden the spectrum of control, i.e. chewing and sucking insects at a time, decrease chances of development and management of resistance and to enhance residual control so lesser the number of sprays for crop protections and minimizing the pesticidal load in ecosystem. The combination of insecticides at times demonstrate an additive or synergistic effect that results in an improved control on the pests.

Insecticide or pesticides are used widely and very frequently in commercial agriculture and have enabled an enormous increase in crop yields and product quality which ultimately increased the ease to farmers in term of economic advantage as well as ease of farming activities.

There are many combinations of insecticide known in the art for the control of soil borne pests. For example, ES2707398 patent relates to certain substituted bicyclic azoles, their N-oxides, salts and compositions suitable for agronomic and non-agronomic uses, and methods of their use for controlling invertebrate pests such as arthropods in both agronomic and non-agronomic media.

Further it relates to a Methoxyfenozide insecticide along with insecticide chlorantraniliprole, cyantraniliprole, tetraniliprole.

AU2015285316 patent relates to a pesticide an insecticidal, miticidal, nematicidal, molluscicidal, microbicidal, or bactericidal composition comprising at least two types of active compounds with amounts that are synergistically active, comprising chlorantraniliprole, cyantraniliprole, tetraniliprole.

U.S. Pat. No. 10,219,516B2 patent relates to the field of molecules having pesticidal utility against pests in Phyla Arthropoda, Mollusca, and Nematoda, processes to produce such molecules, intermediates used in such processes, pesticidal compositions containing such molecules, and processes of using such pesticidal compositions against such pests. This patent discloses the composition comprising insecticide like Methoxyfenozide chlorantraniliprole, cyantraniliprole, tetraniliprole and various other insecticidal compounds.

JP2017178802 patent relates to a new technique for efficiently controlling pests that are difficult or impossible to control with conventional techniques. A pest control composition comprising insecticides discloses Methoxyfenozide, chlorantraniliprole, cyantraniliprole, tetraniliprole and in combination with various insecticidal compounds.

EP2582242B1 patent relates to a combinations of active substances with insecticidal and acaricidal properties. The patent further relates to a combination of methoxyfenozide and Flubendiamide, emamectin benzoate in combination with various insecticidal and acaricidal compounds.

US20040220199A1 patent relates to combination of pesticides to control of plant pests and more particularly to the provision of protection against insect damage to seeds and plant parts. The patent further relates to the combination of methoxyfenozide along with different group of insecticides from a phenyl pyrazole, an organophosphate and a carbamate.

There is however a need for improvement of these combinations. Single active combinations used over a long period of time has resulted in resistance. With the onset of resistance to certain pests, there is a need in the art for a combination of actives that decreases chances of resistance and improves the spectrum of disease and pest control.

### OBJECTS OF THE INVENTION

However still there is a need for a composition comprises at least one Diacylhydrazines group of insecticide; insecticide from diamide or a pyridylpyrazole group of compounds; and at least one insecticide selected from compound having various mode of action which overcomes some of the existing problems and can be prepared easily without much complex manufacturing process.

Diacylhydrazines have an excellent environmental profile, are essentially non-toxic to mammals and other vertebrates, and have exhibited low toxicity towards most non-target invertebrates, including beneficial insects and bees. Therse are being Ecdyson inhibitors is very novel mode of action, so this is very important insecticide to delay resistance especially in lepidopteran insects.

In general use, the pesticide actives are used in the form of a dilute aqueous composition because it can attain a good interaction with the target organism, such as plants, fungi and insects. However, most active pesticide compounds that are used as pesticides are only sparingly or even insoluble in water. The low solubility of such compounds present the challenges and difficulties to formulator in formulating pesticide compounds in stable formulations that can be easily stored for a long time and which still have a high stability and effective activity until end use. This problem especially occurs and may get worsen if more than one active compound is present in the composition.

Therefore, one object of the present invention is to provide improved combinations of insecticides for the control of Foliar feeder and soil born pests. Another object of the present invention is to provide a method and a composition for controlling insect pests.

Yet another object of the present invention is to provide improved combinations of insecticides that promote plant health.

Embodiment of the present invention can ameliorate one or more of the above mentioned problems.

Inventors of the present invention have surprisingly found that the novel synergistic composition of at least one Diacylhydrazines group of insecticide; insecticide from diamide or a pyridylpyrazole group of compounds; and at least one insecticide selected from compound having various mode of action as described herein which can provide solution to the above mentioned problems.

### SUMMARY OF THE INVENTION

Therefore an aspect of the present invention provides an insecticidal composition comprising (A) at least one insecticide from diacylhydrazines group; (B) at least one insecticide from diamide or a pyridylpyrazole group; (C) at least one insecticidal compound selected from the group consisting of an acetylcholineo esterase inhibitors from the class of carbamates, acetylcholine esterase inhibitors from the class of organophosphates, cyclodiene organochlorine compounds, fiproles, sodium channel modulators from the class of pyrethroids, nicotinic acteylcholine receptor agonists from the class of neonicotinoids, allosteric nicotinic acteylcholine receptor activators from the class of spinosyns, chloride channel activators from the class of mectins, juvenile hormone mimics, non-specific multi-site inhibitors, selective homopteran feeding blockers, mite growth inhibitors, microbial disruptors of insect midgut membrane, inhibitors of mitochondrial ATP synthase, uncouplers of oxidative phosphorylation, nicotinic acetylcholine receptor channel blockers, inhibitors of the chitin biosynthesis affecting CHS1, inhibitors of the chitin biosynthesis type 1, moulting disruptors, Octopamin receptor agonists, Mitochondrial complex III electron transport inhibitors, Mitochondrial complex I electron transport inhibitors, Voltage-dependent sodium channel blockers, Inhibitors of the lipid synthesis, inhibitors of acetyl CoA carboxylase, Mitochondrial complex II electron transport inhibitors, chlorodontal organ modulators, Baculoviruses, Compounds of unknown or uncertain mode of action; and one or more customary formulation adjuvants.

More particularly an aspect of the present invention provides an insecticidal composition comprising (A) at least one Diacylhydrazines group of insecticide selected from the group of selected from Chromafenozide, Halofenozide, Methoxyfenozide, Tebufenozide and mixture thereof; (B) at least one insecticide from diamide or a pyridylpyrazole group selected from broflanilide, chlorantraniliprole, cyantraniliprole, cyclaniliprole, cyhalodiamide, flubendiamide, tetrachlorantraniliprole, and tetraniliprole; (C) at least one insecticidal compound selected from Profenofos, Fipronil, Bifenthrin, lambda-cyhalothrin, Clothiandin, Dinotefuran, Thiamethoxam, Spinetoram, Spinosad, Emamectin benzoate, Novaluron, Indoxacarb, Azadirechtin; and one or more customary formulation adjuvants.

Accordingly, in a further aspect, the present invention provides a method of protecting a plant propagation material, a plant, parts of a plant and/or plant organs that grow at a later point in time against pathogenic damage or pest damage by applying to the plant propagation material a composition comprising an insecticidal composition defined in the first aspect.

As per one embodiment formulation for the an insecticidal composition is selected from Capsule suspension (CS), Dispersible concentrate (DC), Powder for dry seed treatment (DS), Emulsifiable concentrate (EC), Emulsion, water in oil (EO), Emulsion for seed treatment (ES), Emulsion, oil in water (EW), Flowable suspension/concentrate for seed treatment (FS), Granule/ soil applied (GR), Controlled (Slow or Fast) release granules (CR), Solution for seed treatment (LS), Micro-emulsion (ME), Oil dispersion (OD), Oil miscible flowable concentrate (oil miscible suspension (OF), Oil miscible liquid (OL), Suspension concentrate (flowable concentrate) (SC), Suspo-emulsion (SE), Water soluble granule (SG), Soluble concentrate (SL), Water soluble powder (SP), Water dispersible granule (WG or WDG), Wettable powder (WP), Water dispersible powder for slurry treatment (WS), A mixed formulation of CS and SC (ZC), A mixed formulation of CS and SE (ZE), A mixed formulation of CS and EW (ZW); and and one or more customary formulation adjuvants such as a) dispersant b) wetting agent c) anti-foaming agent d) biocides e) anti-freezing agent f) suspending agent g) thickener h) coating agent and i) buffering agent.

The remainder of the aqueous formulation is preferably wholly water but may comprise other materials, such as inorganic salts. The formulation is preferably, completely free from organic solvents.

Accordingly, in a first aspect, the present invention provides an insecticidal composition comprising (A) at least one Diacylhydrazines group of insecticide selected from the group of selected from Chromafenozide, Halofenozide, Methoxyfenozide, Tebufenozide and mixture thereof; (B) at least one insecticide from diamide or a pyridylpyrazole group selected from chlorantraniliprole, cyantraniliprole, cyclaniliprole, cyhalodiamide, cyproflanilide, flubendiamide, tetraniliprole, tetrachlorantraniliprole, broflanilide, fluxametamide and isocycloseram (C) at least one insecticidal compound selected from Acephate, Profenofos, Fipronil, Nicofluprole, Bifenthrin, lambda-cyhalothrin, Clothiandin, Dinotefuran, Thiamethoxam, Spinetoram, Spinosad, Emamectin benzoate, Novaluron, Indoxacarb, Afidopyropen, Flonicamid, Pymetrozine, Triflumezopyrim, Azadirechtin, Oxazosulfyl, dimpropyridaz and tyclopyrazoflor; and one or more customary formulation adjuvants; shows synergistic activity.

### DETAILED DESCRIPTION OF THE INVENTION

The term “synergistic”, as used herein, refers the combined action of two or more active agents blended together and administered conjointly that is greater than the sum of their individual effects.

“Bioactive amounts” as mentioned herein means that amount which, when applied treatment of crops, is sufficient to effect such treatment.

Therefore an aspect of the present invention provides an insecticidal composition comprising (A) at least one insecticide from diacylhydrazines group; (B) at least one insecticide from diamide or a pyridylpyrazole group; (C) at least one insecticidal compound selected from the group consisting of an acetylcholineo esterase inhibitors from the class of carbamates, acetylcholine esterase inhibitors from the class of organophosphates, cyclodiene organochlorine compounds, fiproles, sodium channel modulators from the class of pyrethroids, nicotinic acteylcholine receptor agonists from the class of neonicotinoids, allosteric nicotinic acteylcholine receptor activators from the class of spinosyns, chloride channel activators from the class of mectins, juvenile hormone mimics, non-specific multi-site inhibitors, selective homopteran feeding blockers, mite growth inhibitors, microbial disruptors of insect midgut membrane, inhibitors of mitochondrial ATP synthase, uncouplers of oxidative phosphorylation, nicotinic acetylcholine receptor channel blockers, inhibitors of the chitin biosynthesis affecting CHS1, inhibitors of the chitin biosynthesis type 1, moulting disruptors, Octopamin receptor agonists, Mitochondrial complex III electron transport inhibitors, Mitochondrial complex I electron transport inhibitors, Voltage-dependent sodium channel blockers, Inhibitors of the lipid synthesis, inhibitors of acetyl CoA carboxylase, Mitochondrial complex II electron transport inhibitors, chlorodontal organ modulators, Baculoviruses, Compounds of unknown or uncertain mode of action; and one or more customary formulation adjuvants.

In an embodiment of the present invention the insecticede from group of diacylhydrazines may be selected from Chromafenozide, Halofenozide, methoxyfenozide, tebufenozide.

In an embodiment of the present invention the insecticede from group of a diamide insecticide or a pyridylpyrazole insecticide may be selected from chlorantraniliprole, cyantraniliprole, cyclaniliprole, cyhalodiamide, cyproflanilide, flubendiamide, tetraniliprole, tetrachlorantraniliprole, broflanilide, fluxametamide and isocycloseram.

In an embodiment of the present invention the insecticede from acetylcholine esterase inhibitors from the class of carbamates may be selected from aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, and triazamate.

In an embodiment of the present invention the insecticede acetylcholine esterase inhibitors from the class of organophosphates may be selected from acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion; M-2 GABA-gated chloride channel antagonists.

In a further embodiment of the present invention the insecticede from cyclodiene organochlorine class of compound is endosulfan.

In a further embodiment of the present invention the insecticede from fiproles class may be selected from ethiprole, fipronil, nicofluprole, flufiprole, pyrafluprole, or pyriprole.

In a further embodiment of the present invention the insecticede from sodium channel modulators from the class of pyrethroids may be selected from acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, meperfluthrin, metofluthrin, momfluorothrin, permethrin, phenothrin, prallethrin, profluthrin, pyrethrin (py rethrum), resmethrin, silafluofen, tefluthrin, tetramethylfluthrin, tetramethrin, tralomethrin, transfluthrin.

In a further embodiment of the present invention the insecticede from nicotinic acteylcholine receptor agonists from the class of neonicotinoids may be selected from acetamiprid, chlothianidin, dinotefuran, imidacloprid, nitenpyram, thiacloprid, thiamethoxam, sulfoxaflor, flupyradifurone flupyrimin or triflumezopyrim.

In a yet another embodiment of the present invention the insecticede from allosteric nicotinic acteylcholine receptor activators from the class of spinosyns may be selected from spinosad, spinetoram.

In a yet another embodiment of the present invention the insecticede from chloride channel activators from the class of mectins may be selected from abamectin, emamectin benzoate, ivermectin, lepimectin or milbemectin.

In a yet another embodiment of the present invention the insecticede from selective homopteran feeding blockers from the class of pyridine azomethine derivatives may be selected from pymetrozine, pyrifluquinazon.

In a yet another embodiment of the present invention the insecticede from selective homopteran feeding blockers from the class of pyropenes is afidopyropen.

In a yet another embodiment of the present invention the insecticede from mite growth inhibitors may be selected from clofentezine, hexythiazox, diflovidazin or etoxazole.

In a yet another embodiment of the present invention the insecticede from microbial disruptors of insect midgut membrane may be selected from Bacillus thuringiensis and insecticidal proteins they produce.

In a yet another embodiment of the present invention the insecticede from class of inhibitors of mitochondrial ATP synthase may be selected from diafenthiuron, azocyclotin, cyhexatin, fenbutatin oxide, propargite, or tetradifon.

In a yet another embodiment of the present invention the insecticede from class of uncouplers of oxidative phosphorylation may be selected from chlorfenapyr, DNOC, or sulfluramid.

In a yet another embodiment of the present invention the insecticede from class of nicotinic acetylcholine receptor channel blockers may be selected from bensultap, cartap hydrochloride, thiocyclam, thiosultap sodium.

In a yet another embodiment of the present invention the insecticede from class of inhibitors of the chitin biosynthesis affecting CHS1 may be selected from Benzoylureas-bistrifluron, chlorfluazuron, diflubenzuron, flucycloxuron, flufenoxuron, hexaflumuron, lufenuron, novaluron, noviflumuron, teflubenzuron, triflumuron.

In a yet another embodiment of the present invention the insecticede from class of inhibitors of the chitin biosynthesis type 1 is buprofezin.

In a yet another embodiment of the present invention the insecticede from class of moulting disruptors is cyromazine.

In a yet another embodiment of the present invention the insecticede from class of Octopamin receptor agonists is amitraz.

In a yet another embodiment of the present invention the insecticede from class of Mitochondrial complex III electron transport inhibitors may be selected from hydramethylnon, acequinocyl, flometoquin, fluacrypyrim, pyriminostrobin or bifenazate.

In a yet another embodiment of the present invention the insecticede from class of Mitochondrial complex I electron transport inhibitors may be selected from fenazaquin, fenpyroximate, pyrimidifen, pyridaben, tebufenpyrad, tolfenpyrad, flufenerim, or rotenone.

In a yet another embodiment of the present invention the insecticede from class of voltage-dependent sodium channel blockers may be selected from indoxacarb, metaflumizone or 1-[(E)-[2-(4-cyanophenyl)-1-[3-(trifluoromethyl) phenyl]ethylidene] amino]-3-[4 (difluoromethoxy) phenyl]urea may be selected from fenazaquin, fenpyroximate, pyrimidifen, pyridaben, tebufenpyrad, tolfenpyrad, flufenerim, or rotenone.

In a yet another embodiment of the present invention the insecticede from class of Inhibitors of the lipid synthesis, inhibitors of acetyl CoA carboxylase may be selected from spirodiclofen, spiromesifen, spirotetramat or spiropidion.

In a yet another embodiment of the present invention the insecticede from class of Mitochondrial complex II electron transport inhibitors may be selected from cyenopyrafen, cyflumetofen or pyflubumide.

In a yet another embodiment of the present invention the insecticede from class of chlorodontal organ modulators is flonicamid.

In a yet another embodiment of the present invention the insecticidal compounds of unknown or uncertain mode of action may be selected from azadirechtin, benzoximate, pyridalyl, benzpyrimoxan, oxazosulfyl (ethyl 2-{5-[(trifluoromethyl)sulfonyl]-1,3-benzoxazol-2-yl}-3-pyridyl sulfone); dimpropyridaz (1-[(1RS)-1,2-dimethylpropyl]-N-ethyl-5-methyl-N-pyridazin-4-yl-1H-pyrazole-4-carboxamide), isoxazoline insecticide—tyclopyrazoflor (N-[3-chloro-1-(3-pyridyl)-1H-pyrazol-4-yl]-N-ethyl-3-[(3,3,3-trifluoropropyl)thio]propenamide); fluhexafon.

More particularly an aspect of the present invention provides an insecticidal composition comprising (A) at least one Diacylhydrazines group of insecticide selected from the group of selected from Chromafenozide, Halofenozide, Methoxyfenozide, Tebufenozide; (B) at least one insecticide from group of a diamide insecticide or a pyridylpyrazole insecticide may be selected from chlorantraniliprole, cyantraniliprole, cyclaniliprole, cyhalodiamide, cyproflanilide, flubendiamide, tetraniliprole, tetrachlorantraniliprole, broflanilide, fluxametamide and isocycloseram; (C) at least one insecticidal compound selected from Acephate, Profenofos, Fipronil, Nicofluprole, Bifenthrin, lambda-cyhalothrin, Clothiandin, Dinotefuran, Thiamethoxam, Spinetoram, Spinosad, Emamectin benzoate, Novaluron, Indoxacarb, Afidopyropen, Flonicamid, Pymetrozine, Triflumezopyrim, Azadirechtin, Oxazosulfyl, dimpropyridaz and tyclopyrazoflor; and one or more customary formulation adjuvants.

Most preferably, in a further aspect of the present invention is containing an insecticidal composition of (A) Methoxyfenozide; (B) at least one insecticide from group of chlorantraniliprole, cyantraniliprole Tetraniliprole and broflanilide; (C) at least one insecticidal compound selected from Acephate, Profenofos, Fipronil, Bifenthrin, lambda-cyhalothrin, Clothiandin, Dinotefuran, Thiamethoxam, Pymetrozine, Spinetoram, Spinosad, Emamectin benzoate, Novaluron, Indoxacarb, Azadirechtin.

The present invention provides formulation for the aforesaid composition and method of preparation thereof.

### Diacylhydrazines Group of Insecticide:

Diacylhydrazines are the only group of ecdysone receptor agonist insecticides, which induce premature molting in insects by mimicking the action of the molting hormone ecdysone. Activity is limited to Lepidoptera and Coleoptera, and because the compounds do not penetrate the cuticle well, they must be ingested. Ecdysone receptor agonists provide rapid control in comparison to most insect growth regulators, causing feeding cessation within 3 to 14 hours.

Diacylhydrazine insecticides bind in the ecdysone binding site of the ecdysone receptor-usp dimer, causing it to activate ecdysone-responsive genes that are normally activated during molting and metamorphosis. One of the earliest symptoms, occurring within 3 to 14 hours, is feeding cessation, a normal effect of ecdysone that allows insects to clear food from the gut in preparation for molting. Separation of the old cuticle from the epidermis and synthesis of the new cuticle begins during this time also. The continued activation of ecdysone receptors, in contrast to the brief activation by the pulse of ecdysone in a normal molt, does not allow the proper timing of gene activation. This results in an improperly formed cuticle and mouth parts that are soft and mushy and unable to break the insect out of the old cuticle. The selectivity of diacylhydrazines for Lepidoptera is due in large part to the high selectivity for lepidopteran ecdysone receptors.

Environmental and Toxicological Considerations: Diacylhydrazines have an excellent environmental profile, are essentially non-toxic to mammals and other vertebrates, and have exhibited low toxicity towards most non-target invertebrates, including beneficial insects and bees

Methoxyfenozide is a carbohydrazide that is hydrazine in which the amino hydrogens have been replaced by 3-methoxy-2-methylbenzoyl, 3,5-dimethylbenzoyl, and tert-butyl groups respectively. It has a role as an environmental contaminant, a xenobiotic and an insecticide. It is a carbohydrazide and a monomethoxybenzene. It derives from a N-benzoyl-N-(tert-butyl) benzohydrazide. Methoxyfenozide acts as an insecticide on insects that may be directly harmful, as those acting as disease vectors, or indirectly harmful, as destroyers of crops, food products, or textile fabrics.

### Diamide Group of Insecticides:

Anthranilic diamides are an important commercial synthetic class of insecticides (IRAC Group 28) that bind to the ryanodine receptor with selective potency against insect versus mammalian forms of the receptor. Chlorantraniliprole is first of the anthranilic diamide insecticides. It is a ryanodine receptor activator and is used to protect a wide variety of crops, including corn, cotton, grapes, rice and potatoes. It has a role as a ryanodine receptor agonist. It is an organobromine compound, a member of pyridines, a member of pyrazoles, a pyrazole insecticide, a member of monochlorobenzenes and a secondary carboxamide

Chlorantraniliprole is a novel anthranilic diamide insecticide that functions via activation of the insect ryanodine receptors within the sarcoplasmic reticulum causing impaired regulation of muscle contraction. Ryanodine receptor channels regulate the release of internal calcium stores and are important in muscle contraction. Sustained release of calcium levels within the cytosol leads to muscle contraction, paralysis and eventual death of the organism. While insects possess a single form of the ryanodine receptor distributed in muscle and neuronal tissue, mammals possess three forms which are widely distributed in muscle and non-muscle tissues.

The present inventors believe that the combination of the present invention surprisingly results in a synergistic action. The combinations of the present invention allow for a broad spectrum of pest control and has surprisingly improved plant vigour and yield. The broad spectrum of the present combination also provides a solution for preventing the development of resistance.

The synergistic composition has very advantageous curative, preventive and systemic fungicidal properties for protecting cultivated plants. As has been mentioned, said active ingredient composition can be used to inhibit or destroy the pathogens that occur on plants or parts of plants (fruit, blossoms, leaves, stems, tubers, roots) of different crops or useful plants, while at the same time those parts of plants which grow later are also protected from attack by such pathogens. Active ingredient composition has the special advantage of being highly active against diseases in the soil that mostly occur in the early stages of plant development.

The synergistic composition of pesticide are used to protect the crops and plants from insect and fungus pests. The lists of the major crops includes

genetically modified varieties or hybrid varieties or conventional varieties of Paddy Oryza sativa, Cotton Gossypium spp., Wheat Triticum aestavum, Maize Zea mays, Sugarcane Saccharum officinarum, Soybean Glycin max, Peanut Arachis hypogaea, Sunflower Helianthus annuus, Mustard Brassica juncea, Green gram Vigna radiate, Black gram Vigna mungo, Chickpea Cicer aritinum, Cowpea Vigna unguiculata, Redgram Cajanus cajan, Brinjal Solanum melongena, Cabbage Brassica oleracea var. capitata, Cauliflower Brassica oleracea var. botrytis, Okra Abelmoschus esculentus, Onion Allium cepa L., Tomato Solanum lycopersicun, Potato Solanum tuberosum, Chilly Capsicum annum, Cucumber Cucumis sativus and Melons Cucumis melo, Apple Melus domestica, Banana Musa spp., Citrus groups Citrus spp., Grape Vitis vinifera, Mango Mangifera indica, Papaya Carica papaya, Pomegranate Punica granatum, Tea Camellia sinensis, Coffea Coffea arabica, Cumin Cuminum cyminum etc.

Further the said novel composition can be applied on corn, rice, wheat, barley, rye, oat, sorghum, cotton, soybean, peanut, buckwheat, beet rapeseed, sunflower, sugar cane, tobacco, etc.

The said novel composition can be applied on the vegetables and vegetables crops but not limited to solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit olive, plum, banana, coffee, i¾ date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

The composition according to the invention can be applied to any and all developmental stages of pests, such as egg, larva, pupa, and adult. The pests may be controlled by contacting the target pest, its food supply, habitat, breeding ground or its locus with a pesticidally effective amount of the inventive mixtures or of compositions comprising the mixtures.

The synergistic combination of the present invention used to control the insects-pests belongs to the order of the Lepidoptera, for example Agrotis ypsilon, Alabama argillacea, Anticarsia gemmatalis, Cacoecia murinana, Capua reticulana, Chilo auricilius, Chilo infuscatellus, Chilo partellus, Chilo sacchariphagus, Chilo suppressalis, Choristoneura fumiferana, Choristoneura occidentalis, Cirphis unipuncta, Cnaphalocrocis medinalis, Cydia pomonella, Diatraea saccharalis, Dendrolimus pini, Diaphania nitidalis, Earias vittella, Earias insulana, Elasmopalpus lignosellus, Emmalocera depressella, Eupoecilia ambiguella, Evetria bou-liana, Exelastis atomosa, Feltia subterranea, Galleria mellonella, Grapholitha funebrana, Helicoverpa armigera, Helicoverpa virescens, Helicoverpa zea, Hellula undalis, Hibernia defoliaria, Hyphantria cunea, Hyponomeuta malinellus, Keiferia lycopersicella, Laphygma exigua, Leucinodes orbonalis, Leucoptera coffeella, Leucoptera scitella, Lithocol-letis blancardella, Lobesia botrana, Loxostege sticticalis, Lymantria dispar, Lymantria monacha, Lyonetia clerkella, Malacosoma neustria, Mamestra brassicae, Marasmia pantalis, Maruca vitrata, Maruca testulalis, Mythimna separata, Orgyia pseu-dotsugata, Ostrinia nubilalis, Panolis flammea, Pectinophora gossypiella, Peridroma saucia, Phalera bucephala, Phthorimaea operculella, Phyllocnistis citrella, Pieris bras-sicae, Plathypena scabra, Plutella xylostella, Pseudoplusia includens, Rhyacionia frus-trana, Scirpophaga excerptallis, Scirpophaga incertulas, Scirpophaga innotata, Scrobipalpula absoluta, Sesamia inferens, Sitotroga cerealella, Sparganothis pilleriana, Spilosoma obliqua, Spodoptera frugiperda, Spodoptera littoralis, Spodoptera litura, Thaumatopoea pityocampa, Tortrix viridana, Trichoplusia ni, Tryporyza novella, Tuta absoluta and Zeiraphera Canadensis.

beetles (Coleoptera), for example Adoretus bicolor, Agrilus sinuatus, Agriotes lineatus, Agriotes obscu-rus, Amphimallus solstitialis, Anisandrus dispar, Anthonomus grandis, Anthonomus pomorum, Anomala benghalensis, Aphthona euphoridae, Apogonia aerea, Athous haemorrhoidalis, Atomaria linearis, Blasto-phagus piniperda, Blitophaga undata, Bruchus rufimanus, Bruchus pisorum, Bruchus lentis, Byctiscus betulae, Cassida nebulosa, Cerotoma trifurcata, Cetonia aurata, Ceuthorrhynchus assimilis, Ceuthorrhynchus napi, Chaetocnema tibialis, Chiloloba acuta, Conoderus vespertinus, Crioceris asparagi, Ctenicera ssp., Diabrotica longicornis, Diabrotica semipunctata, Diabrotica punctata, Diabrotica speciosa, Diabrotica virgifera, Dicladispa armigera, Epila-chna varivestis, Epitrix hirtipennis, Eutinobothrus brasiliensis, Holotrichia bicolor, Holotrichia consanguinea, Holotrichia serrata, Hylobius abietis, Hypera brunneipennis, Hypera postica, Ips typographus, Lema bilineata, Lema melanopus, Leptinotarsa decemlineata, Lepidiota stigma, Limonius califomicus, Lissorhoptrus oryzophilus, Maladera indica, Melanotus communis, Meligethes aeneus, Melolontha hippocastani, Melolontha melolontha, Oberea brevis, Oulema oryzae, Ortiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popillia japonica, Sitona lineatus and Sito-philus gran aria.

flies, mosquitoes (Diptera), e.g. Atherigona orientalis, Calliphora vicina, Ceratitis capitata, Chrysomya bezziana, Chrysomya hominivorax, Chrysomya macellaria, Chrysops discalis, Chrysops silacea, Chrysops atlanticus, Cochliomyia hominivorax, Contarinia sorghicola Cordylobia anthropophaga, Culicoides furens, Culiseta inornata, Culiseta melanura, Dacus cucurbi-tae, Dacus oleae, Dasineura brassicae, Delia antique, Delia coarctata, Delia platura, Delia radicum, Dermatobia hominis, Fannia canicularis, Geomyza Tripunctata, Gaster-ophilus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia caprina, Lucilia cuprina, Lucilia sericata, Lycoria pectoralis, Mansonia titillanus, Mayetiola destructor, Melanagromyza obtuse, Muscina stabulans, Oestrus ovis, Ophiomyia phaseli, Opomyza florum, Orseolia oryzae, Oscinella frit, Pegomya hysocyami, Phorbia antiqua, Phorbia brassicae, Phor-bia coarctata, Phlebotomus argentipes, Psorophora columbiae, Psila rosae, Psoro-phora discolor, Prosimulium mixtum, Rhagoletis cerasi, Rhagoletis pomonella, Sar-cophaga haemorrhoidalis, Sarcophaga sp., Simulium vittatum, Stomoxys calcitrans, Tabanus bovinus, Tabanus atratus, Tabanus lineola, and Tabanus similis, Tipula ol-eracea, and Tipula paludosa.

Thrips (Thysanoptera), e.g. Dichromothrips corbetti, Dichromothrips ssp, Frankliniella fusca, Frankliniella occidentalis, Frankliniella tritici, Scirtothrips citri, Scirtothrips dorsalis, Thrips oryzae, Thrips palmi and Thrips tabaci.

Termites (Isoptera), e.g. Calotermes flavicollis, Coptotermes formosanus, Heterotermes aureus, Leucotermes flavipes, Microtermes obesi, Odontotermes obesus, Reticulitermes flavipes, Termes natalensis.

Cockroaches (Blattaria-Blattodea), e.g. Blattella germanica, Penplaneta americana, Periplaneta japonica and Blatta orientalis.

true bugs (Hemiptera), e.g. Acrosternum hilare, Acyrtho-siphon pisum, Acyrthosiphon onobrychis, Adelges laricis, Aleurolobus barodensis, Amrasca biguttula biguttula, Amrasca devastans, Amritodus atkinsoni, Aphidula nasturtii, Aphis fabae, Aphis forbesi, Aphis pomi, Aphis gossypii, Aphis crassivora, Aphis grossulariae, Aphis schneideri, Aphis spiraecola, Aphis sambuci, Aulacorthum solani, Bemisia argentifolii, Bemisia tabaci, Brachycaudus cardui, Brachy-caudus helichrysi, Brachycaudus persicae, Brachycaudus prunicola, Brevicoryne brassicae, Capitophorus horni, Cavalerius sweeti, Cerosipha gossypii, Ceratovacuna lanigera, Chaetosiphon fragaefolii, Cicadulina spp., Clavigralla gibbosa, Cryptomyzus ribis, Dreyfusia nordmannianae, Dreyfusia piceae, Dysdercus cingulatus, Dysaphis radicola, Dysaulacorthum pseudosolani, Dysaphis plantaginea, Dysaphis pyri, Empoasca fabae, Hyalopterus pruni, Hyperomyzus lactucae, Idioscopus spp. Leptoglossus phyllopus, Leptocorisa acuta, Lygus lineolaris, Lygus pratensis, Macrosiphum avenae, Macrosiphum euphorbiae, Ma-crosiphon rosae, Megoura viciae, Melanaphis pyrarius, Metopolophium dirhodum, My-zus persicae, Myzus ascalonicus, Myzus cerasi, Myzus varians, Nezara viridula, Nasonovia ribis-nigri, Nilaparvata lugens, Nephotettix virescens, Nephotettix nigropictus, Pemphigus bursarius, Perkinsiella saccharicida, Peregrinus maidis, Phorodon humuli, Planococcus spp., Pseudococcus spp., Pyrilla perpusilla, Psylla mail, Psylla piri, Rhopalomyzus ascalonicus, Rhopalosiphum maidis, Rhopalosi-phum padi, Rhopalosiphum insertum, Saccharicoccus sacchari, Sappaphis mala, Sappaphis mail, Schizaphis graminum, Schizoneura lanuginosa, Sitobion avenae, Sogatella furcifera, Trialeurodes vaporariorum, Toxoptera aurantiia, Psylla spp., Rhopalosiphum spp., Sitobion spp.

ants, bees, wasps, sawflies (Hymenoptera), e.g. Athalia rosae, Atta cephalotes, Atta capiguara, Atta cephalotes, Atta laevigata, Atta robusta, Atta sexdens, Atta texana, Crematogaster spp., Hoplocampa minuta, Hoplocampa testudinea, Monomorium pha-raonis, Solenopsis geminata, Solenopsis invicta, Solenopsis richteri, Solenopsis xyloni, Pogonomyrmex barbatus, Pogonomyrmex californicus, Pheidole megacephala, Dasy-mutilla occidentalis, Bombus spp. Vespula squamosa, Paravespula vulgaris, Paraves-pula pennsylvanica, Paravespula germanica, Dolichovespula maculata, Vespa crabro, Polistes rubiginosa, Camponotus floridanus, and Linepithema humile.

crickets, grasshoppers, locusts (Orthoptera), e.g. Acheta domestica, Gryllotalpa gryllo-talpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus italicus, Chortoicetes terminifera, and Locustana pardalina.

Arachnoidea, such as arachnids (Acarina), e.g. of the families Argasidae, Ixodidae and Sarcoptidae, such as Amblyomma americanum, Amblyomma variegatum, Ambryomma maculatum, Argas persicus, Boophilus annulatus, Boophilus decoloratus, Boophilus microplus, Dermacentor silvarum, Dermacentor andersoni, Dermacentor variabilis, Hyalomma truncatum, Ixodes ricinus, Ixodes rubicundus, Ixodes scapularis, Ixodes holocyclus, Ixodes pacificus, Ornithodorus moubata, Ornithodorus hermsi, Ornithodo-rus turicata, Ornithonyssus bacoti, Otobius megnini, Dermanyssus gallinae, Psoroptes ovis, Rhipicephalus sanguineus, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetra-nychidae spp. such as Tetranychus cinnabarinus, Tetranychus kanzawai, Tetranychus pacificus, Tetranychus telarius and Tetranychus urticae, Panonychus ulmi, Panony-chus citri, and Oligonychus pratensis; Araneida, e.g. Latrodectus mactans, and Loxos-celes reclusa. Fleas (Siphonaptera), e.g. Ctenocephalides felis, Ctenocephalides canis, Xenopsylla cheopis, Pulex irritans, Tunga penetrans, and Nosopsyllus fasciatus. Silverfish, firebrat (Thysanura), e.g. Lepisma saccharina and Thermobia domestica. Centipedes (Chilopoda), e.g. Scutigera coleoptrata. Millipedes (Diplopoda), e.g. Narceus spp. Earwigs (Dermaptera), e.g. Forficula auricularia. lice (Phthiraptera), e.g. Pediculus humanus capitis, Pediculus humanus corporis, Pthi-rus pubis, Haematopinus eurystemus, Haematopinus suis, Linognathus vituli, Bovicola bovis, Menopon gallinae, Menacanthus stramineus and Solenopotes capillatus, plant parasitic nematodes such as root-knot nematodes, Meloidogyne arenaria, Meloi-dogyne chitwoodi, Meloidogyne exigua, Meloidogyne hapla, Meloidogyne incognita, Meloidogyne javanica and other Meloidogyne species; cyst nematodes, Globodera rostochiensis, Globodera pallida, Globodera tabacum and other Globodera species, Heterodera avenae, Heterodera glycines, Heterodera schachtii, Heterodera trifolii, and other Heterodera species; seed gall nematodes, Anguina funesta, Anguina tritici and other Anguina species; stem and foliar nematodes, Aphelenchoides besseyi, Aphelen-choides fragariae, Aphelenchoides ritzemabosi and other Aphelenchoides species; sting nematodes, Belonolaimus longicaudatus and other Belonolaimus species; pine nematodes, Bursaphelenchus xylophilus and other Bursaphelenchus species; ring nematodes, Criconema species, Criconemella species, Criconemoides species, and Me-socriconema species; stem and bulb nematodes, Ditylenchus destructor, Ditylenchus dipsaci, Ditylenchus myceliophagus and other Ditylenchus species; awl nematodes, Dolichodorus species; spiral nematodes, Helicotylenchus dihystera, Helicotylenchus multicinctus and other Helicotylenchus species, Rotylenchus robustus and other Roty-lenchus species; sheath nematodes, Hemicycliophora species and Hemicriconemoides species; Hirshmanniella species; lance nematodes, Hoplolaimus columbus, Hoplolai-mus galeatus and other Hoplolaimus species; false root-knot nematodes, Nacobbus aberrans and other Nacobbus species; needle nematodes, Longidorus elongates and other Longidorus species; pin nematodes, Paratylenchus species; lesion nematodes, Pratylenchus brachyurus, Pratylenchus coffeae, Pratylenchus curvitatus, Pratylenchus goodeyi, Pratylencus neglectus, Pratylenchus penetrans, Pratylenchus scribneri, Pratylenchus vulnus, Pratylenchus zeae and other Pratylenchus species; Radinaphelenchus cocophilus and other Radinaphelenchus species; burrowing nematodes, Radopholus similis and other Radopholus species; reniform nematodes, Rotylenchulus reniformis and other Rotylenchulus species; Scutellonema species; stubby root nematodes, Tri-chodorus primitivus and other Trichodorus species; Paratrichodorus minor and other Paratrichodorus species; stunt nematodes, Tylenchorhynchus claytoni, Tylenchorhyn-chus dubius and other Tylenchorhynchus species and Merlinius species; citrus nematodes, Tylenchulus semipenetrans and other Tylenchulus species; dagger nematodes, Xiphinema americanum, Xiphinema index, Xiphinema diversicaudatum and other Xi-phinema species; and other plant parasitic nematode species.

Formulation of the present invention can be in any of the formulations selected from Capsule suspension (CS), Dispersible concentrate (DC), Powder for dry seed treatment (DS), Emulsifiable concentrate (EC), Emulsion, water in oil (EO), Emulsion for seed treatment (ES), Emulsion, oil in water (EW), Flowable suspension/concentrate for seed treatment (FS), Granule/soil applied (GR), Controlled (Slow or Fast) release granules (CR), Solution for seed treatment (LS), Micro-emulsion (ME), Oil dispersion (OD), Oil miscible flowable concentrate (oil miscible suspension (OF), Oil miscible liquid (OL), Suspension concentrate (=flowable concentrate) (SC), Suspo-emulsion (SE), Water soluble granule (SG), Soluble concentrate (SL), Water soluble powder (SP), Water dispersible granule (WG or WDG), Wettable powder (WP), Water dispersible powder for slurry treatment (WS), A mixed formulation of CS and SC (ZC), A mixed formulation of CS and SE (ZE), A mixed formulation of CS and EW (ZW).

One or more of the active ingredients is encapsulated for various purposes, such as to increase the residual biological activity, or to reduce the acute toxicity, or to obtain a physical or chemically stable water-based formulation. The purpose determines whether the “free” active ingredient and the “release rate” are relevant properties of a specific product.

Further composition comprising of (A) an insecticide from diacylhydrazines group; (B) an insecticide from diamide or a pyridylpyrazole group; and (C) at least one insecticidal compound selected from Acephate, Profenofos, Fipronil, Bifenthrin, lambda-cyhalothrin, Clothiandin, Dinotefuran, Thiamethoxam, Pymetrozine, Spinetoram, Spinosad, Emamectin benzoate, Novaluron, Indoxacarb, Azadirechtin; which are bio active ingredient for the present composition are present in specific fixed ratio.

One or more of the active ingredients can be encapsulated for various purposes, such as to increase the residual biological activity, or to reduce the acute toxicity, or to obtain a physical or chemically stable water-based formulation. The purpose determines whether the “free” active ingredient and the “release rate” are relevant properties of a specific product.

Further (A) an insecticide from diacylhydrazines group present in an amount of 1-30% by weight; (B) an insecticide from diamide or a pyridylpyrazole group present in an amount of 1-20% by weight; and (C) an insecticide selected from Acephate, Profenofos, Fipronil, Nicofluprole, Bifenthrin, lambda-cyhalothrin, Clothianidin, Dinotefuran, Thiamethoxam, Spinetoram, Spinosad, Emamectin benzoate, Novaluron, Indoxacarb, Afidopyropen, Flonicamid, Pymetrozine, Triflumezopyrim, Azadirechtin, Oxazosulfyl, dimpropyridaz and tyclopyrazoflor present in an amount of 0.5-50% by weight; along with inactive excipients are present in fixed specific percentage by weight.

| Compounds | Compound A | Compound B | Compound C |
|---|---|---|---|
| Composition | an insecticide from | an insecticide from | A group of |
| | diacylhydrazines | diamide or a | insecticides |
| | group | pyridylpyrazole | |
| | | group | |
| Ratio | 1%-30% w/w | 1%-20% w/w | 0.5%-50% w/w |

The process for preparing the present synergistic mixture can be modified accordingly by any person skilled in the art based on the knowledge of manufacturing the formulation. However all such variations and modifications are covered by the scope of the present invention.

The composition of the present invention in addition to bioactive amounts of active ingredients further comprises inactive excipients including but not limited to dispersant or dispersing agent, anti-freezing agent, anti-foam agent, wetting agent, suspension aid, thickener and preservative.

A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank or other vessel to reduce the wetting time of wettable powders and to improve the penetration of water into water-dispersible granules.

Examples of wetting agent used herein for Suspension Concentrate (SC) formulation include but not limited to ethylene oxide/propylene oxide block copolymer, polyaryl phenyl ether phosphate, ethoxylated fatty alcohol, sodium dioctyl sulfosuccinate, sodium lauryl sulfate and sodium dodecyl benzene sulfonate, alkyl diphenyl sulfonates, sodium isopropyl naphthalene sulfonate, alkyl naphthalene sulfonate, organosilicone surfactants includes trisiloxane ethoxylate, polydimethylsiloxane, polyoxyethylene methyl polysiloxane, polyoxyalkylene methyl polysiloxane, polyether polymethyl siloxane copolymer.

Examples of wetting agent used herein for Capsule Suspension (CS) formulation include but not limited to Ethylene oxide/propylene oxide block copolymer, Polyaryl phenyl ether phosphate, Ethoxylated Fatty Alcohol, Sodium dioctyl sulfosuccinate, sodium lauryl sulphate and sodium dodecyl benzene sulfonate, alkyl diphenyl sulfonates, sodium isopropyl naphthalene sulfonate, Alkyl naphthalene sulfonate, Octyl phenol ethoxylate, alkyl phenol ethoxylate.

Examples of wetting agent used herein for Wettable Granules (WG) formulation include but not limited to sodium N-methyl-N-oleoyl taurate, alkylated naphthalene sulfonate, sodium salt, mixture of isomers of dibutyl naphthalene sulphonic acid sodium salt, sodium di-isopropyl naphthalene sulphonate, sodium Lauryl sulfate, dioctyl sulfate, alkyl naphthalene sulfonates, phosphate esters, sulphosuccinates and non-ionic such as tridexyl alcohol ethoxylate, alkyl or alkaryl sulfonates such as alkylbenzene sulfonates, alpha olefin sulfonate and alkyl naphthalene sulfonates, ethoxylated or non-ethoxylated alkyl or alkaryl carboxylates, alkyl or alkyaryl phosphate esters, alkyl polysaccharide, di or mono alkyl sulfosuccinate derivatives, alpha olefin sulfonates, alkyl naphthalene sulfonates, dialkyl sulphosuccinates, butyl, dibutyl, isopropyl and diisopropyl naphthalene sulfonate salts, C₁₂ alkyl benzene sulfonate or C₁₀-C₁₆ alkyl benzene sulfonate.

Examples of Wetting-spreading-penetrating agent used herein for Capsule Suspension (CS) formulation include but not limited to Organosilicone surfactants includes trisiloxane ethoxylate, polydimethylsiloxane, polyoxyethylene methyl polysiloxane, polyoxyalkylene methyl polysiloxane, polyether polymethyl siloxane copolymer, heptamethyl trisiloxane, Polyalkyleneoxide modified heptamethyl trisiloxane, polyether modified polysiloxane, 10 mole ethylene oxide adduct of octylphenol, may or may not be in modified form, may be liquid or powder form or mixture thereof.

Examples of Wetting-spreading-penetrating agent used herein for Wettable Granules (WG) formulation include but not limited to Organosilicone surfactants includes trisiloxane ethoxylate, polydimethylsiloxane, polyoxyethylene methyl polysiloxane, polyoxyalkylene methyl polysiloxane, polyether polymethyl siloxane copolymer, heptamethyl trisiloxane, Polyalkyleneoxide modified heptamethyl trisiloxane, polyether modified polysiloxane, 10 mole ethylene oxide adduct of octylphenol, may or may not be in modified form, may be liquid or powder form or mixture thereof.

A dispersant or a dispersing agent is a substance which adsorbs onto the surface of particles and helps to preserve the state of dispersion of the particles and prevents them from re-aggregating. Dispersants are added to agrochemical formulations to facilitate dispersion and suspension during manufacture, and to ensure the particles re-disperse into water in a spray tank. They are widely used in wettable powders, suspension concentrates and water-dispersible granules. Surfactants that are used as dispersants have the ability to adsorb strongly onto a particle surface and provide a charged or steric barrier to re-aggregation of particles. The most commonly used surfactants are anionic, non-ionic, or mixtures of the two types. For wettable powder formulations, the most common dispersants are sodium lingo sulphonates. In recent years, new types of very high molecular weight polymeric surfactants have been developed as dispersants. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces.

Examples of dispersing agent used herein for Suspension Concentrate (SC) formulation include but not limited to alkylated naphthalene sulfonate, sodium salt, sodium salt of naphthalene sulfonate condensate, sodium ligno sulfonate, sodium polycarboxylate, EO/PO based copolymer, phenol sulfonate, sodium methyl oleoyl taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fatty amine polyethylene oxide, nonylphenol polyglycolether with 9-10 moles ethylene oxide.

Examples of dispersing agent used herein for Capsule Suspension (CS) formulation include but not limited to Ethoxylated lignosulfonic acid salts, lignosulfonic acid salts, oxidized lignins, lignin salts, salts of styrenemaleic anhydride copolymers, polyvinyl alcohol, salts of partial esters of styrene-maleic anhydride copolymers, partial salts of polyacrylic acid and partial salts of polyacrylic acid terpolymers. the surfactant is lignosulfonate of calcium or sodium or mixtures thereof or a modified kraft lignin with a high sulfonic acid group, dibutylnaphthalenesulfonic acid, fatty acids, alkyl- and alkylarylsulfonates, alkyl sulfates, lauryl ether sulfates and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkyl phenyl polyglycol ethers, tributyl phenyl polyglycol ethers, alkyl aryl polyether alcohols, is tridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-sulphite waste liquors, and proteins, denatured proteins, polysaccharides, ammonium salts of sulfonates, sulfates, phosphates or carboxylates, alkylarylsulfonates, diphenyl sulfonates, alpha-olefin sulfonates, sulfonates of fatty acids and oils, sulfonates of ethoxylated alkylphenols, sulfonates of condensed naphthalene, sulfonates of dodecyl- and tridecyl benzenes, sulfonates of naphthalene and alkylnaphthalenes, sulfosuccinates or sulfosuccinates, alkoxylates, N-alkylated fatty acid amides, amine oxides, esters or sugar-based surfactants, alkylphenols, amines (e.g. tallow amine), amides, aryl phenols, fatty acids or fatty acid esters which have been alkoxylated. Ethylene oxide and/or propylene oxide may be employed for the alkoxylation, preferably ethylene oxide, polyethylene oxide and polypropylene oxide, polyacids or polybases.

Examples of dispersing agent used herein for Wettable Granules (WG) formulation include but not limited to naphthalene sulfonic acid, sodium salt condensated with formaldehyde, polyalcoxylated alkylphenol, naphthalene sulfonic acid formaldehyde condensate, methyl naphtaline-formaldehyde-condensate sodium salt, naphthalene condensates, lignosulfonates, polyacrylates and phosphate esters, calcium lignosulfonate, lignin sulfonate sodium salt.

Antifoaming agent for the present formulation is selected from various compounds and selectively used according to the formulation. Generally, there are two types of antifoam agents, namely silicones and non-silicones. Silicones are usually aqueous emulsions of dimethyl poly siloxane while the non-silicone anti-foam agents are water-insoluble oils, such as octanol and nonanol, or silica. In both cases, the function of the anti-foam agent is to displace the surfactant from the air-water interface.

Examples of Antifoaming agent used herein for Suspension Concentrate (SC) formulation include but not limited to silicone oil, silicone compound, C10˜C20 saturated fat acid compounds or C8˜C10 aliphatic alcohols compound, silicone antifoam emulsion, dimethylsiloxane, polydimethyl siloxane, vegetable oil based antifoam, tallow based fatty acids, polyalkyleneoxide modified polydimethylsiloxane.

Examples of Antifoaming agent used herein for Capsule Suspension (CS) formulation include but not limited to silicone oil, silicone compound, C10˜C20 saturated fat acid compounds or C8˜C10 aliphatic alcohols compound, Silicone antifoam emulsion, Dimethyl siloxane, Polydimethyl siloxane, Vegetable oil based antifoam, tallow based fatty acids, polyalkyleneoxide modified polydimethylsiloxane.

Examples of Antifoaming agent used herein for Wettable Granules (WG) formulation include but not limited to polydimethylsiloxane.

Examples of Anti-freezing agent used herein for Suspension Concentrate (SC) formulation include but not limited to ethylene glycol, propane diols, glycerine or the urea, glycol (monoethylene glycol, diethylene glycol, polypropylene glycol, polyethylene glycol), glycerine, urea, magnesium sulfate heptahydrate, sodium chloride.

Examples of Anti-freezing agent used herein for Capsule Suspension (CS) formulation include but not limited to ethylene glycol, propane diols, glycerine or the urea, Glycol (Monoethylene glycol, Diethylene glycol, Polypropylene glycol, Polyethylene glycol), Glycerine, Urea, Magnesium sulphate heptahydrate, sodium chloride.

Examples of Preservatives used herein for Suspension Concentrate (SC) formulation include but not limited to 1,2-benzisothiazolin-3(2H)-one, sodium salt, sodium benzoate, 2-bromo-2-nitropropane-1,3-diol, formaldehyde, sodium o-phenylphenate, 5-chloro-2-methyl-4-isothiazolin-3-one & 2-methyl-4-isothiazolin-3-one.

Examples of Preservatives used herein for Capsule Suspension (CS) formulation include but not limited to 1,2-benzisothiazolin-3(2H)-one, sodium salt, Sodium benzoate, 2-bromo-2-nitropropane-1,3-diol, Formaldehyde, Sodium o-phenyl phenate, 5-chloro-2-methyl-4-isothiazolin-3-one & 2-methyl-4-isothiazolin-3-one.

Examples of Thickeners used herein for Suspension Concentrate (SC) formulation include but not limited to xanthan gum, PVK, carboxymethylcelluloses, polyvinyl alcohols, gelatin, sodium carboxymethylcellulose, hydroxyethylcellulose, sodium polyacrylate, modified starch.

Examples of Thickeners used herein for Capsule Suspension (CS) formulation include but not limited to Xanthan gum, Carboxy methyl cellulose, Attapulgite clay, Bentonite clay.

Suspension aid or the suspending agent in the present description denotes a natural or synthetic, organic or inorganic material with which the active substance is combined in order to facilitate its application to the plant, to the seeds or to the soil. This carrier is hence generally inert, and it must be agriculturally acceptable, in particular to the plant being treated. The carrier may be solid (clays, natural or synthetic silicates, silica, resins, waxes, solid fertilizers, and the like or mixtures thereof) or liquid (water, alcohols, ketones, petroleum fractions, aromatic or paraffinic hydrocarbons, chlorinated hydrocarbons, liquefied gases, and the like or mixtures thereof).

Examples of suspending agent used herein for Suspension Concentrate (SC) formulation include but not limited to aluminum magnesium silicate, bentonite clay, silica, attapulgite clay.

Examples of suspending agent used herein for Capsule Suspension (CS) formulation include but not limited to aluminum magnesium silicate, bentonite clay, silica, attapulgite clay.

Examples of buffering agent used herein for Capsule Suspension (CS) formulation include but not limited to Sodium hydroxide, potassium hydroxide, acetic acid, sulphuric acid, hydrochloric acid, ortho phosphoric acid, ammonium hydroxide.

Examples of solvent used herein for Capsule Suspension (CS) formulation include but not limited to Hydrocarbon solvent such a an aliphatic, cyclic and aromatic hydrocarbons (e.g. toluene, xylene, paraffin, tetrahydro naphthalene, alkylated naphthalene or their derivatives, mineral oil fractions of medium to high boiling point (such as kerosene, diesel oil, coal tar oils)); a vegetable oil such as corn oil, rapeseed oil; a fatty acid ester such as C1-C10-alkylester of a C10-C22-fatty acid; or, methyl- or ethyl esters of vegetable oils such as rapeseed oil methyl ester or corn oil methyl ester, acetophenone, 2-Heptanon, 3-heptanone, 2-hexanone, 5-methyl-2-hexanone, 5-methyl-3-heptanone, 3-methyl-2-hexanone, 4-methyl-2-hexanone, 2-methyl-3-hexanone, 4-methyl-3-hexanone, 5-methyl-3-hexanone, 3-ethyl-2-pentanone, 3,3-dimethyl-2-pentanone, 3,4-dimethyl-2-pentanone, 4,4-dimethyl-2-pentanone, 2,2-dimethyl-3-pentanone, 2,4-dimethyl-3-pentanone, 2-octanone, 2,5-dimethyl-3-hexanone, 2,2-dimethyl-3-hexanone, 3,3-dimethyl-2-hexanone, 3,4-dimethyl-2-hexanone, 4,4-dimethyl-3-hexanone, 3-ethyl-4-methyl-2-pentanone, 2-methyl-3-heptanone, 2-methyl-4-heptanone, 3-methyl-2-heptanone, 3-methyl-4-heptanone, 5-methyl, 3-heptanone, 6-methyl-2-heptanone, 6-methyl-3-heptanone, 3-octanone, 4-octanone, 2,2,4-trimethyl-3-pentanone, 3-ethyl-3-methyl-2-pentanone, 5-methyl-2-heptanone, isoprene.

Examples of Carrier used herein for Wettable Granules (WG) formulation include but not limited to china clay, silica, lactose anhydrous, ammonium sulfate, sodium sulfate anhydrous, corn starch, urea, EDTA, urea formaldehyde resin, diatomaceous earth, kaolin, bentonite, kieselguhr, fuller's earth, attapulgite clay, bole, loess, talc, chalk, dolomite, limestone, lime, calcium carbonate, powdered magnesia, magnesium oxide, magnesium sulphate, sodium chloride, gypsum, calcium sulphate, pyrophyllite, silicates and silica gels; fertilizers such as, for example, ammonium sulphate, ammonium phosphate, ammonium nitrate and urea; natural products of vegetable origin such as, for example, grain meals and flours, bark meals, wood meals, nutshell meals and cellulosic powders; and synthetic polymeric materials such as, for example, ground or powdered plastics and resins, bentonites, zeolites, titanium dioxide, iron oxides and hydroxides, aluminium oxides and hydroxides, or organic materials such as bagasse, charcoal, or synthetic organic polymers.

Examples of disintegrating agents used herein for Wettable Granules (WG) formulation include but not limited to citric acid, succinic acid or the sodium bicarbonate.

Examples of Wall forming agent 1 used herein for Capsule Suspension (CS) formulation include but not limited to Tetramethylene diisocyanate, pentamethylene diisocyanate, hexamethylene diisocyanate, toluene diisocyanate, diphenylmethene-4,4′-diisocyanate, polymethylene polyphenylene isocyanate, 2,4,4′-diphenyl ether tri-isocyanate, 3,3′-dimethyl-4,4′-diphenyl diisocyanate, 3,3′-dimethoxy-4,4′-diphenyl diisocyanate, 1,5-naphthylene diisocyanate and 4,4′4″-triphenylmethane tri-isocyanate, toluene diisocyanate or polymethylene polyphenylisocyanate, polyurethane comprising of polyfunctional iso cyanate and a polyamine in polarized form.

Examples of Wall forming agent 2 used herein for Capsule Suspension (CS) formulation include but not limited to Ammonia, hexamine, ethylenediamine, propylene-1,3-diamine, tetramethylenediamine, pentamethylenediamine, 1,6-hexamethylenediamine, diethylenetriamine, triethylenetetramine, tetra ethylene pentamine, pentaethylenehexamine, 4,9-dioxadodecane-1,12-diamine, 1,3-phenylenediamine, 2,4- and 2,6-toluenediamine and 4,4′-diaminodiphenylmethane, 1,3-phenylenediamine, 2,4- and 2,6-toluenediamine, 4,4′-diaminodiphenylmethane, 1,5-diaminonaphthalene, 1,3,5 -triaminobenzene, 2,4,6-triaminotoluene, 1,3,6-triaminonaphthalene, 2,4,4′-triaminodiphenyl ether, 3,4,5-triamino-1,2,4-triazole and 1,4,5,8-tetraminoanthraquinone.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. The invention shall now be described with reference to the following specific examples. It should be noted that the example(s) appended below illustrate rather than limit the invention, and that those skilled in the art will be able to design many alternative embodiments without departing from the scope of the present invention.

These and other aspects of the invention may become more apparent from the examples set forth herein below. These examples are provided merely as illustrations of the invention and are not intended to be construed as a limitation thereof.

### EXAMPLE 1

### Suspension Concentrate (SC) Formulation of Methoxyfenozide 15%+Cyantrnailiprole 10%+Clothianidin 8%

| Chemical composition | % (w/w) |
|---|---|
| Methoxyfenozide | 15.00 |
| Cyantraniliprole | 10.00 |
| Clothianidin | 8.00 |
| Wetting-spreading-penetrating agent | 3.00 |
| Dispersing agent 1 | 4.50 |
| Dispersing agent 2 | 3.00 |
| Suspending agent | 2.00 |
| Antifoaming agent | 0.30 |
| Preservative | 0.20 |
| Antifreezing agent | 5.00 |
| Thickener | 0.15 |
| Diluent Water | 48.85 |
| Total | 100.00 |

### Storage Stability—Methoxyfenozide 15%+Cyantraniliprole 10%+Clothianidin 8% Suspension Concentrate (SC) Formulation

Laboratory storage stability

| | Specification | | At 54 ± | At 0 ± |
|---|---|---|---|---|
| Parameters | (in house) | Initial | 2° C. | 2° C. |
| Methoxyfenozide content percent by mass | 14.25 to 15.75 | 15.70 | 15.40 | 15.60 |
| Cyantraniliprole content percent by mass | 9.50 to 10.5 | 10.40 | 10.20 | 10.30 |
| Clothianidin content percent by mass | 7.60 to 8.80 | 8.50 | 8.30 | 8.40 |
| Methoxyfenozide suspensibility percent min. | 80 | 97.80 | 96.80 | 97.40 |
| Cyantraniliprole suspensibility percent min. | 80 | 98.00 | 97.00 | 97.60 |
| Clothianidin suspesnibility precent min. | 80 | 98.40 | 97.70 | 98.00 |
| pH range (1% aq. Suspension) | 4.0 to 6.5 | 5.60 | 5.50 | 5.60 |
| Pourability | 95% min. | 97.50 | 97.00 | 97.40 |
| Specific gravity | 1.02-1.08 | 1.03 | 1.03 | 1.03 |
| Viscosity at spindle no. 62, 20 rpm | 350-800 cps | 650 | 660 | 650 |
| Particle size (micron) | D50 < 3, | 2.1, 8.2 | 2.4, 8.5 | 2.5, 8.6 |
| | D90 < 10 | | | |
| Persistent foam ml (after 1 minute) max. | 60 | nil | 3 | nil |

Room temperature storage stability up to 12 months

| | Specification | 1 | 6 | 12 |
|---|---|---|---|---|
| Parameters | (in house) | month | month | month |
| Methoxyfenozide content percent by mass | 14.25 to 15.75 | 15.70 | 15.50 | 15.30 |
| Cyantraniliprole content percent by mass | 9.50 to 10.5 | 10.40 | 10.30 | 10.20 |
| Clothianidin content percent by mass | 7.60 to 8.80 | 8.50 | 8.40 | 8.20 |
| Methoxyfenozide suspensibility percent min. | 80 | 97.80 | 97.40 | 97.00 |
| Cyantraniliprole suspensibility percent min. | 80 | 98.00 | 97.50 | 96.80 |
| Clothianidin suspesnibility precent min. | 80 | 98.40 | 98.00 | 97.20 |
| pH range (1% aq. Suspension) | 4.0 to 6.5 | 5.60 | 5.50 | 5.40 |
| Pourability | 95% min. | 97.50 | 97.20 | 96.60 |
| Specific gravity | 1.02-1.08 | 1.03 | 1.03 | 1.03 |
| Viscosity at spindle no. 62, 20 rpm | 350-800 cps | 650 | 650 | 620 |
| Particle size (micron) | D50 < 3, | 2.1, 8.2 | 2.2, 8.4 | 2.4, 8.8 |
| | D90 < 10 | | | |
| Persistent foam ml (after 1 minute) max. | 60 | nil | 2 | nil |

### Procedure: Manufacturing Process for Suspension Concentrate (SC) Formulation:

Preparation of Suspension Concentrate (SC) formulation:

| | |
|---|---|
| Step 1 | 2% Gel Preparation: Charge the required quantity of water to a vessel, equipped with a |
| | high shear stirrer and start the agitation. Add the required amount of preservative. Mix |
| | until homogenous. Add the required amount of thickener and mix vigorously until it is |
| | fully wetted. |
| Step 2 | Charge the required quantity of water to a vessel, equipped with bulk agitator and a |
| | high shear homogenizer and start agitation. Add the required amount of ant freezing |
| | agent and mix until uniform. Add the antifoaming agent and ensure that it is well |
| | dispersed. Add the wetting and dispersing agent and mix until uniform. Ensure that the |
| | dispersing agent is fully dispersed. |
| Step 3 | Now add the active ingredient and continue agitating the vessel contents until all |
| | components get dissolved. Mill this pre-mix through a Colloid mill and subsequently |
| | through a Dyno mill to meet the specified particle size. |
| Step 4 | Now add remaining antifoaming agent to this SC mill base to a vessel, equipped with |
| | bulk agitator. Mix until uniform. Add the required amount of 2% aqueous pre-gel and |
| | suspending agent and continue agitation until the formulation is homogeneous and has |
| | the target viscosity is reached. |
| Step 5 | Final product is sent for QC approval. |
| Step 6 | After approval, material is packed in required pack sizes. |

### EXAMPLE 2

### ZC Formulation of Methoxyfenozide 9%+Chlorantraniliprole 2%+Lambda Cyhalothrin 1%

| Chemical composition | % (w/w) |
|---|---|
| Methoxyfenozide | 9.00 |
| Chlorantraniliprole | 2.00 |
| Lambda cyhalothrin | 1.00 |
| Wetting agent | 4.50 |
| Dispersing agent 1 | 4.50 |
| Dispersing agent 2 | 2.00 |
| Solvent | 8.00 |
| Wall forming material 1 | 1.00 |
| Wall forming material 2 | 0.50 |
| Suspending agent | 1.50 |
| Antifoaming agent | 0.30 |
| Buffering agent | 0.50 |
| Preservative | 0.20 |
| Antifreezing agent | 5.00 |
| Thickener | 0.15 |
| Diluent Water | 59.85 |
| Total | 100.00 |

### Storage Stability—Methoxyfenozide 9%+Chlorantraniliprole 2%+Lambda Cyhalothrin 1% ZC Formulations.

Laboratory storage for 14 days

| | Specification | | At 54 ± | At 0 ± |
|---|---|---|---|---|
| Parameters | (in house) | Initial | 2° C. | 2° C. |
| Methoxyfenozide content percent by mass | 8.55 to 9.90 | 9.80 | 9.40 | 9.70 |
| Chlorantraniliprole content percent by mass | 1.90 to 2.20 | 2.15 | 2.10 | 2.13 |
| Lambda cyhalothrin content percent by mass | 0.95 to 1.10 | 1.05 | 1.03 | 1.04 |
| Methoxyfenozide suspensibility percent min. | 80 | 97.8 | 96.8 | 97.2 |
| Chlorantraniliprole suspensibility percent min. | 80 | 98.2 | 97.5 | 97.8 |
| Lambda cyhalothrin suspesnibility precent min. | 80 | 98.2 | 97.2 | 97.6 |
| pH range (1% aq. Suspension) | 5.0 to 7.0 | 6.00 | 5.90 | 6.00 |
| Pourability | 95% min. | 97.5 | 97.1 | 97.4 |
| Specific gravity | 1.05-1.10 | 1.05 | 1.05 | 1.05 |
| Viscosity at spindle no. 62, 20 rpm | 350-800 cps | 580 | 560 | 570 |
| Particle size (micron) | D50 < 3, | 2.0, 8.0 | 2.2, 8.2 | 2.1, 8.1 |
| | D90 < 10 | | | |
| Persistent foam ml (after 1 minute) max. | 60 | nil | 2.8 | nil |

Room temperature storage

| | Specification | 1 | 6 | 12 |
|---|---|---|---|---|
| Parameters | (in house) | month | month | month |
| Methoxyfenozide content percent by mass | 8.55 to 9.90 | 9.80 | 9.60 | 9.50 |
| Chlorantraniliprole content percent by mass | 1.90 to 2.20 | 2.15 | 2.12 | 2.10 |
| Lambda cyhalothrin content percent by mass | 0.95 to 1.10 | 1.05 | 1.04 | 1.02 |
| Methoxyfenozide suspensibility percent min. | 80 | 97.8 | 97.0 | 96.6 |
| Chlorantraniliprole suspensibility percent min. | 80 | 98.2 | 97.8 | 97.2 |
| Lambda cyhalothrin suspesnibility precent min. | 80 | 98.2 | 97.6 | 97.0 |
| pH range (1% aq. Suspension) | 5.0 to 7.0 | 6.0 | 6.1 | 6.3 |
| Pourability | 95% min. | 97.5 | 97.0 | 96.5 |
| Specific gravity | 1.05-1.10 | 1.05 | 1.06 | 1.06 |
| Viscosity at spindle no. 62, 20 rpm | 350-800 cps | 580 | 600 | 620 |
| Particle size (micron) | D50 < 3, | 2.0, 8.0 | 2.2, 8.2 | 2.3, 8.5 |
| | D90 < 10 | | | |
| Persistent foam ml (after 1 minute) max. | 60 | nil | nil | 2 |

Procedure: Manufacturing process for ZC Formulation.

Preparation of ZC (mixture of CS and SC) Formulation:

| | |
|---|---|
| Part A | Preparation of CS (Capsule Suspension) formulation |
| Step 1 | Aqueous Phase-Charge water to a stainless-steel vessel equipped with a high speed |
| | stirrer. Under agitation, add the wetting agent, dispersing agent 1and dispersing agent |
| | 2 into the vessel. Now add 50% quantity of antifoam to avoid foam generation in this |
| | vessel. |
| Step 2 | Organic Phase-Charge heavy aromatic hydrocarbons solvent into second stainless- |
| | steel reactor. Then, slowly add melted active ingredient into the reactor. Afterwards, |
| | charge wall forming material 1 material to the reactor. Continue mixing. Cool the |
| | reactor contents to room temperature. |
| Step 3 | Start the high shear disperser of aqueous phase and charge the ‘Organic Solution’ into |
| | the ‘Aqueous Phase Solution’ under gravity in specific rate so that required particle |
| | size can be achieved and continue to shear for 30 min. Then, start heating the reactor |
| | to around 50° C. and stir the formulation under slow rpm for 3-4 hours so that |
| | Polymerization reaction gets completed. |
| Step 4 | Now add wall forming material 2 so that residual wall forming material 1 can be |
| | consumed and stir for 1 more hour at the same temperature and if required add half |
| | quantity of antifoam to remove foam generating due to CO₂ during reaction. |
| Step 5 | After the wall polymerization reaction, increase the agitator to high speed. Add the |
| | rest half quantity of antifoam to the formulation. Under slight vacuum, allow the |
| | mixture to de-gas for approximately 30 minutes to remove CO₂ from the solution. |
| | Add the linear polysaccharide, preservative and in last freezing agent and mix for |
| | some minutes. Add buffering agent for pH adjustment. Check the formulation to |
| | specifications |
| Part B | Preparation of SC (Suspension Concentrate) formulation |
| Step 1 | 2% Gel Preparation: Charge the required quantity of water to a vessel, equipped with |
| | a high shear stirrer and start the agitation. Add the required amount of preservative. |
| | Mix until homogenous. Add the required amount of thickener and mix vigorously |
| | until it is fully wetted. |
| Step 2 | SC Premix- Charge the required quantity of water to a vessel, equipped with bulk |
| | agitator and a high shear homogenizer and start agitation. Add the required amount of |
| | ant freezing agent and mix until uniform. Add the antifoaming agent and ensure that it |
| | is well dispersed. Add the wetting and dispersing agent and mix until uniform. Ensure |
| | that the dispersing agent is fully dispersed. |
| Step 3 | Now add the active ingredient and continue agitating the vessel contents until all |
| | components get dissolved. Mill this pre-mix through a Colloid mill and subsequently |
| | through a Dyno mill to meet the specified particle size. |
| Step 4 | Now add remaining antifoaming agent to this SC mill base to a vessel, equipped with |
| | bulk agitator. Mix until uniform. Add the required amount of 2% aqueous pre-gel and |
| | suspending agent and continue agitation until the formulation is homogeneous and has |
| | the target viscosity. Mix well. |
| Part C | Preparation of ZC Formulation |
| Step 1 | Charge the required quantity of SC formulation into a vessel, equipped with bulk |
| | agitator and start agitation. Add the CS Premix to this slurry and mix slowly until |
| | uniform. Add the required amount of 2% pre-gel and continue agitation until the |
| | formulation is homogeneous and a target viscosity of around 600-800 m cPs is |
| | reached. Mix well. |
| Step 2 | Final product is sent for QC approval. |
| Step 3 | After approval, material is packed in required pack sizes. |

### EXAMPLE 3

### ZC Formulation of Methoxyfenozide 15%+Tetraniliprole 6%+Emamectin Benzoate 1.5%

| Chemical composition | % (w/w) |
|---|---|
| Methoxyfenozide | 15.00 |
| Tetraniliprole | 6.00 |
| Emamectin benzoate | 1.50 |
| Wetting agent | 4.50 |
| Dispersing agent 1 | 4.50 |
| Dispersing agent 2 | 2.00 |
| Solvent | 8.00 |
| Wall forming material 1 | 1.00 |
| Wall forming material 2 | 0.50 |
| Suspending agent | 1.50 |
| Antifoaming agent | 0.30 |
| Buffering agent | 0.50 |
| Preservative | 0.20 |
| Antifreezing agent | 5.00 |
| Thickener | 0.15 |
| Diluent Water | 49.35 |
| Total | 100.00 |

Storage Stability—Storage stability study in laboratory and at room temperature shows that Methoxyfenozide 15%+Tetraniliprole 6%+Emamectin benzoate 1.5% ZC formulation complies all the in-house parameters like active ingredients content, suspensibility, pH, pourability, specific gravity, viscosity, particle size and anti-foaming.

### Procedure: Manufacturing Process for ZC Formulation as per Example 2

### EXAMPLE 4

Most preferred combinations and formulations thereof:

| | Compound B- | | | | | |
|---|---|---|---|---|---|---|
| Compound A- | Diamide or | | Active ingredients (%) | | | |
| Diacylhydrazines | pyridylpyrazole | Compound C- | Compound | Compound | Compound | Formulation |
| group | group | Insecticide(s) | A | B | C | Type |
| Methoxyfenozide | Chlorantraniliprole | Lambda | 9 | 2 | 1 | ZC |
| | | cyhalotrhin | | | | |
| Methoxyfenozide | Cyantraniliprole | Lambda | 9 | 5 | 1 | ZC |
| | | cyhalotrhin | | | | |
| Methoxyfenozide | Tetraniprole | Lambda | 9 | 5 | 1 | ZC |
| | | cyhalotrhin | | | | |
| Methoxyfenozide | Cyclaniliprole | Lambda | 9 | 5 | 1 | ZC |
| | | cyhalotrhin | | | | |
| Methoxyfenozide | Flubendiamide | Lambda | 9 | 2 | 1 | ZC |
| | | cyhalotrhin | | | | |
| Methoxyfenozide | Isocycloseram | Lambda | 9 | 5 | 1 | ZC |
| | | cyhalotrhin | | | | |
| Methoxyfenozide | Chlorantraniliprole | Emamectin | 15 | 6 | 1.5 | ZC |
| | | benzoate | | | | |
| Methoxyfenozide | Cyantraniliprole | Emamectin | 15 | 6 | 1.5 | ZC |
| | | benzoate | | | | |
| Methoxyfenozide | Tetraniprole | Emamectin | 15 | 6 | 1.5 | ZC |
| | | benzoate | | | | |
| Methoxyfenozide | Cyclaniliprole | Emamectin | 15 | 6 | 1.5 | ZC |
| | | benzoate | | | | |
| Methoxyfenozide | Flubendiamide | Emamectin | 15 | 6 | 1.5 | ZC |
| | | benzoate | | | | |
| Methoxyfenozide | Isocycloseram | Emamectin | 15 | 6 | 1.5 | ZC |
| | | benzoate | | | | |
| Methoxyfenozide | Chlorantraniliprole | Dimpropyridaz | 12 | 5 | 4 | SC |
| Methoxyfenozide | Cyantraniliprole | Dimpropyridaz | 12 | 8 | 4 | SC |
| Methoxyfenozide | Tetraniprole | Dimpropyridaz | 12 | 8 | 4 | SC |
| Methoxyfenozide | Cyclaniliprole | Dimpropyridaz | 12 | 8 | 4 | SC |
| Methoxyfenozide | Flubendiamide | Dimpropyridaz | 12 | 6 | 4 | SC |
| Methoxyfenozide | Broflanilide | Dimpropyridaz | 12 | 2 | 4 | SC |
| Methoxyfenozide | Fluxametamide | Dimpropyridaz | 12 | 2 | 4 | SC |
| Methoxyfenozide | Isocycloseram | Dimpropyridaz | 12 | 2 | 4 | SC |
| Methoxyfenozide | Chlorantraniliprole | Clothianidin | 15 | 5 | 8 | SC |
| Methoxyfenozide | Cyantraniliprole | Clothianidin | 15 | 10 | 8 | SC |
| Methoxyfenozide | Tetraniprole | Clothianidin | 15 | 10 | 8 | SC |
| Methoxyfenozide | Cyclaniliprole | Clothianidin | 15 | 10 | 8 | SC |
| Methoxyfenozide | Flubendiamide | Clothianidin | 15 | 5 | 8 | SC |
| Methoxyfenozide | Broflanilide | Clothianidin | 15 | 2 | 8 | SC |
| Methoxyfenozide | Fluxametamide | Clothianidin | 15 | 2 | 8 | SC |
| Methoxyfenozide | Isocycloseram | Clothianidin | 15 | 2 | 8 | SC |
| Methoxyfenozide | Chlorantraniliprole | Triflumezopyrim | 14 | 5 | 4 | SC |
| Methoxyfenozide | Cyantraniliprole | Triflumezopyrim | 14 | 8 | 4 | SC |
| Methoxyfenozide | Tetraniprole | Triflumezopyrim | 14 | 8 | 4 | SC |
| Methoxyfenozide | Cyclaniliprole | Triflumezopyrim | 14 | 8 | 4 | SC |
| Methoxyfenozide | Flubendiamide | Triflumezopyrim | 14 | 5 | 4 | SC |
| Methoxyfenozide | Broflanilide | Triflumezopyrim | 14 | 2 | 4 | SC |
| Methoxyfenozide | Fluxametamide | Triflumezopyrim | 14 | 2 | 4 | SC |
| Methoxyfenozide | Isocycloseram | Triflumezopyrim | 14 | 2 | 4 | SC |
| Methoxyfenozide | Chlorantraniliprole | Pymetrozine | 15 | 5 | 30 | WG |
| Methoxyfenozide | Cyanatraniliprole | Pymetrozine | 15 | 10 | 30 | WG |
| Methoxyfenozide | Tetraniliprole | Pymetrozine | 15 | 10 | 30 | WG |
| Methoxyfenozide | Cyclaniliprole | Pymetrozine | 15 | 10 | 30 | WG |
| Methoxyfenozide | Flubendiamide | Pymetrozine | 15 | 5 | 30 | SC |
| Methoxyfenozide | Broflanilide | Pymetrozine | 15 | 2 | 30 | SC |
| Methoxyfenozide | Fluxametamide | Pymetrozine | 15 | 2 | 30 | SC |
| Methoxyfenozide | Isocycloseram | Pymetrozine | 15 | 2 | 30 | SC |
| Methoxyfenozide | Chlorantraniliprole | Fipronil | 15 | 5 | 6 | SC |
| Methoxyfenozide | Cyantraniliprole | Fipronil | 15 | 8 | 6 | SC |
| Methoxyfenozide | Tetraniprole | Fipronil | 15 | 8 | 6 | SC |
| Methoxyfenozide | Cyclaniliprole | Fipronil | 15 | 8 | 6 | SC |
| Methoxyfenozide | Flubendiamide | Fipronil | 15 | 5 | 6 | SC |
| Methoxyfenozide | Broflanilide | Fipronil | 15 | 2 | 6 | SC |
| Methoxyfenozide | Fluxametamide | Fipronil | 15 | 2 | 6 | SC |
| Methoxyfenozide | Isocycloseram | Fipronil | 15 | 2 | 6 | SC |
| Methoxyfenozide | Chlorantraniliprole | Diafenthiuron | 7.5 | 2.5 | 25 | SC |
| Methoxyfenozide | Cyantraniliprole | Diafenthiuron | 7.5 | 5 | 25 | SC |
| Methoxyfenozide | Tetraniprole | Diafenthiuron | 7.5 | 5 | 25 | SC |
| Methoxyfenozide | Cyclaniliprole | Diafenthiuron | 7.5 | 5 | 25 | SC |
| Methoxyfenozide | Flubendiamide | Diafenthiuron | 7.5 | 2.5 | 25 | SC |
| Methoxyfenozide | Broflanilide | Diafenthiuron | 7.5 | 1 | 25 | SC |
| Methoxyfenozide | Fluxametamide | Diafenthiuron | 7.5 | 1 | 25 | SC |
| Methoxyfenozide | Isocycloseram | Diafenthiuron | 7.5 | 1 | 25 | SC |

### BIOLOGICAL EXAMPLES

A synergistic effect exists wherever the action of a combination of active ingredient is greater than the sum of the action of each of the components alone. Therefore, a synergistically effective amount or an effective amount of a synergistic composition or combination is an amount that exhibits greater pesticidal activity than the sum of the pesticidal activities of the individual components.

In the field of agriculture, it is often understood that the term “synergy” is as defined by Colby S. R. in an article entitled “ Calculation of the synergistic and antagonistic responses of herbicide combinations” published in the journal Weeds, 1967, 15, p. 20-22, incorporated herein by reference in its entirety. The action expected for a given combination of two or three active components can be calculated as follows:

Colby's formula for calculating synergism between three active ingredients

$$E = ( X + Y + Z ) - \frac{( XY + XZ + YZ )}{100} + \frac{( XYZ )}{10000}$$

### Where,

E=Expected % control by mixture/combination of Compound A, Compound B and Compound C in a defined dose
X=Observed % control by Compound A
Y=Observed % control by Compound B
Z=Observed % control by Compound C

$$Ratio = \frac{Observed Value ( \% control )}{Expected Value ( \% control )}$$

If ratio of O/E>1, means synergism observed

Colby's formula for calculating synergism between two active ingredients

$$E = X + Y - \frac{XY}{100}$$

### Where,

E=Expected % control by mixture/combination of Compound A and Compound B in a defined dose
Observed % control by Compound A
Y=Observed % control by Compound B

$$Ratio = \frac{Observed value ( \% control )}{Expected value ( \% control )}$$

Ratio of O/E>1, means synergism observed

### FIELD BIO-EFFICACY STUDIES

The field trials have been carried out on different crops to judge the synergism and benefits of innovative ready-mix combinations in comparison to prior arts.

### Experiment 1: Control of Lepidopteran Insect-Pests of Paddy/Rice Crop

Crop: Paddy
Location: Kurud, Dhamtari, Chattishgarh
Plot size: 24 sq. mt. (6 m×4 m)
Number of Treatments: 28
Application Time: 32 DATP (Days after transplanting)
Method of Application: Foliar spray with battery operated knap sack sprayer
Agronomic Practices: All agronomic practices followed as per the crop requirement.
Observation Methods:
Leaf folder (Cnaphalocrocis medinalios) & stem borer (Scirpophaga incertulas) control:

The infestation by stem borer was observed as dead heart (DH) symptoms and leaf folder as damaged leaves (LFD) during vegetative stage. Record the observations from 10 hills per plot at 10 days after spray. The leaf was considered to be damaged by the leaf folder if at least ⅓ of its area showed symptoms.

The percentage of DH and LFD in each individual plot was calculated by using formulae described below:

$$Dead Heart ( DH \% ) = \frac{Number of dead heart per 10 hills}{Total number of tillers per 10 hills} \times 100 \\ \% Stem borer control ( Dead Heart symptoms ) = 100 - \frac{Dead heart ( \% ) in treatment}{Dead heart ( \% ) in untreated} \times 100 \\ Leaf folder damage ( LFD \% ) = \frac{Number of infested leaves per 10 hills}{Total number of leaves per 10 hills} \times 100 \\ Leaf folder control ( \% ) = 100 - \frac{Leaf folder damage ( \% ) in treatment}{Leaf folder damage ( \% ) in untreated} \times 100$$

The calculated value of % control was used to worked out the Colby's formula to judge the synergism.

Productive Tiller count: Count the number of productive tillers per hill. Record observations from 10 hills per plot at the time of harvesting.

TABLE 1
Treatment details for bio-efficacy against lepidopteran insect-pests of paddy crop

| Treatment | |
|---|---|
| Number | Treatment details with application Rate (ml or g per Hectare) |
| T1 | Methoxyfenozide 9% + Chlorantraniliprole 2% + Lambda Cyhalothrin 1% ZC-1000 |
| | ml (ready-mix) |
| T2 | Methoxyfenozide 9% + Cyantraniliprole 5% + Lambda Cyhalothrin 1% ZC-1000 ml |
| | (ready-mix) |
| T3 | Methoxyfenozide 9% + Tetraniliprole 5% + Lambda Cyhalothrin 1% ZC-1000 ml |
| | (ready-mix) |
| T4 | Methoxyfenozide 9% + Cyclaniliprole 5% + Lambda Cyhalothrin 1% ZC-1000 ml |
| | (ready-mix) |
| T5 | Methoxyfenozide 9% + Flubendiamide 2% + Lambda Cyhalothrin 1% ZC-1000 ml |
| | (ready-mix) |
| T6 | Methoxyfenozide 9% + Isocycloseram 5% + Lambda Cyhalothrin 1% ZC-1000 ml |
| | (ready-mix) |
| T7 | Lambda cyhalothrin 5% EC-200 ml + Chlorantraniliprole 18.5% SC-100 ml (prior |
| | art) |
| T8 | Lambda cyhalothrin 5% EC-200 ml + Cyantraniliprole 10.26% OD-500 ml (prior |
| | art) |
| T9 | Lambda cyhalothrin 5% EC-200 ml + Tetraniliprole 20% SC-250 ml (prior art) |
| T10 | Lambda cyhalothrin 5% EC-200 ml + Cyclaniliprole 4.5% SL-1000 ml (prior art) |
| T11 | Lambda cyhalothrin 5% EC-200 ml + Flubendiamide 20% WG-100 g (prior art) |
| T12 | Lambda cyhalothrin 5% EC-200 ml + Isocycloseram 10% DC-500 ml (prior art) |
| T13 | Methoxyfenozide 21.8% SC-375 ml + Chlorantraniliprole 18.5% SC-100 ml (prior |
| | art) |
| T14 | Methoxyfenozide 21.8% SC-375 ml + Cyantraniliprole 10.26% OD-500 ml (prior |
| | art) |
| T15 | Methoxyfenozide 21.8% SC-375 ml + Tetraniliprole 20% SC-250 ml (prior art) |
| T16 | Methoxyfenozide 21.8% SC-375 ml + Cyclaniliprole 4.5% SL-1000 ml (prior art) |
| T17 | Methoxyfenozide 21.8% SC-375 ml + Flubendiamide 20% WG-100 g (prior art) |
| T18 | Methoxyfenozide 21.8% SC-375 ml + Isocycloseram 10% DC-500 ml (prior art) |
| T19 | Methoxyfenozide 21.8% SC-375 ml + Lambda cyhalothrin 5% EC-200 ml (prior |
| | art) |
| T20 | Chlorantraniliprole 18.5% SC-100 ml |
| T21 | Cyantraniliprole 10.26% OD-500 ml |
| T22 | Tetraniliprole 20% SC-250 ml |
| T23 | Cyclaniliprole 4.5% SL-1000 ml |
| T24 | Flubendiamide 20% WG-100 g |
| T25 | Isocycloseram 10% DC-500 ml |
| T26 | Lambda cyhalothrin 5% EC-200 ml |
| T27 | Methoxyfenozide 21.8% SC-375 ml |
| T28 | UTC (Untreated Check) |

TABLE 2
Control of lepidopteran insect-pests of paddy

| | % Leaf folder control | | | % Stem borer control | | | | |
|---|---|---|---|---|---|---|---|---|
| | | | Colby/s | | | Colby/s | | Productive |
| Treatment | Obs. | Cal. | Ratio | Obs. | Cal. | Ratio | Synergism | tillers per |
| number | Value | Value | O/E | Value | Value | O/E | (Y/N) | sq. m. |
| T1 | 100 | 91.51 | 1.09 | 99.4 | 89.96 | 1.10 | Y | 308.8 |
| T2 | 100 | 91.20 | 1.10 | 99.2 | 89.15 | 1.11 | Y | 312.2 |
| T3 | 100 | 90.61 | 1.10 | 98.6 | 88.69 | 1.11 | Y | 305.8 |
| T4 | 100 | 91.02 | 1.10 | 100 | 88.87 | 1.13 | Y | 310.2 |
| T5 | 100 | 90.61 | 1.10 | 98.6 | 88.52 | 1.11 | Y | 307.4 |
| T7 | 77.8 | 79.50 | 0.98 | 75.6 | 79.26 | 0.95 | N | 286.8 |
| T8 | 76.8 | 78.74 | 0.98 | 76.2 | 77.59 | 0.98 | N | 287.2 |
| T9 | 75.4 | 77.31 | 0.98 | 75.4 | 76.64 | 0.98 | N | 288.6 |
| T10 | 77.2 | 78.30 | 0.99 | 74.8 | 76.99 | 0.97 | N | 284.6 |
| T11 | 76.6 | 77.31 | 0.99 | 75.4 | 76.28 | 0.99 | N | 286.4 |
| T12 | 74.2 | 75.45 | 0.98 | 74.2 | 75.33 | 0.99 | N | 289.2 |
| T13 | 82.6 | 84.52 | 0.98 | 82.6 | 83.16 | 0.99 | N | 281.4 |
| T14 | 81.4 | 83.94 | 0.97 | 80.2 | 81.80 | 0.98 | N | 280.6 |
| T15 | 80.8 | 82.86 | 0.98 | 80.6 | 81.03 | 0.99 | N | 282.6 |
| T16 | 82.6 | 83.61 | 0.99 | 79.8 | 81.32 | 0.98 | N | 283.4 |
| T17 | 81.8 | 82.86 | 0.99 | 78.4 | 80.74 | 0.97 | N | 281.2 |
| T18 | 80.2 | 81.45 | 0.98 | 78.4 | 79.96 | 0.98 | N | 279.6 |
| T19 | 75.8 | 77.31 | 0.98 | 68.6 | 71.15 | 0.96 | N | 280.8 |
| T20 | 62.6 | | | 65.2 | | | | 261.4 |
| T21 | 61.2 | | | 62.4 | | | | 264.8 |
| T22 | 58.6 | | | 60.8 | | | | 260.6 |
| T23 | 60.4 | | | 61.4 | | | | 263.4 |
| T24 | 58.6 | | | 60.2 | | | | 260.2 |
| T25 | 55.2 | | | 58.6 | | | | 256.2 |
| T26 | 45.2 | | | 40.4 | | | | 242.8 |
| T27 | 58.6 | | | 51.6 | | | | 251.2 |
| T28 | 0.0 | | | 0.0 | | | | 224.8 |

All the innovative ready-mix combinations (T1, T2, T3, T4, T5 and T6) provides synergistic control of paddy leaf folder and stem borer and also produces more number of productive tillers in comparison to all prior art treatments (T7 to T19).

### Experiment 2: Residual Control of DBM (Diamond Back Moth) Plutella xylostella Infesting Cabbage Crop

Crop & Variety: Cabbage
Location: Padra, Dist. Baroda, Gujarat
Treatments: 28
Plot size: 24 sq.m.
Crop age: 60 days after transplanting. Average 8 to 10 larvae per plant.
Spray water volume: 500 liter per hectare
Method of Application: Foliar spray with battery operated knapsack sprayer fitted with hollow cone nozzle.
Agronomic Practices: Except insecticidal applications, all agronomic practices followed as per the crop requirement.

Observation Methods:

DBM (Diamond back moth) larval control (%):

10 plants per plot were selected randomly. Count the number of live larvae per plant. Calculate % DBM larval control. Record the observations on 3^{rd}, 7th, 10^{th} and 14^{th} days after spraying.

$$\% Larval control = 100 - \frac{Number of live larva in treated plot}{Number of live larvae in untreated control} \times 100$$

% larval control data were used to check the synergism by applying Colby's formula given

TABLE 3
Treatment details for residual control of DBM infesting cabbage crop

| Treatment | |
|---|---|
| Number | Treatment details with application Rate (ml or g per Hectare) |
| T1 | Methoxyfenozide 15% + Chlorantraniliprole 6% + Emamectin benzoate 1.5% ZC- |
| | 500 (ready-mix) |
| T2 | Methoxyfenozide 15% + Cyantraniliprole 6% + Emamectin benzoate 1.5% ZC- |
| | 500 ml (ready-mix) |
| T3 | Methoxyfenozide 15% + Tetraniliprole 6% + Emamectin benzoate 1.5% ZC-500 |
| | ml (ready-mix) |
| T4 | Methoxyfenozide 15% + Cyclaniliprole 6% + Emamectin benzoate 1.5% ZC-500 |
| | ml (ready-mix) |
| T5 | Methoxyfenozide 15% + Flubendiamide 6% + Emamectin benzoate 1.5% ZC-500 |
| | ml (ready-mix) |
| T6 | Methoxyfenozide 15% + Isocycloseram 6% + Emamectin benzoate 1.5% ZC-500 |
| | ml (ready-mix) |
| T7 | Chlorantraniliprole 18.5% SC-150 ml + Emamectin benzoate 5% SG-150 g (prior |
| | art) |
| T8 | Cyantraniliprole 10.26% OD-300 ml + Emamectin benzoate 5% SG-150 g (prior |
| | art) |
| T9 | Tetraniliprole 20% SC-150 ml + Emamectin benzoate 5% SG-150 g (prior art) |
| T10 | Cyclaniliprole 4.5% SL-600 ml + Emamectin benzoate 5% SG-150 g (prior art) |
| T11 | Flubendiamide 20% WG-150 g + Emamectin benzoate 5% SG-150 g (prior art) |
| T12 | Isocycloseram 10% DC-300 ml + Emamectin benzoate 5% SG-150 g (prior art) |
| T13 | Methoxyfenozide 21.8% SC-312.5 ml + Chlorantraniliprole 18.5% SC-150 ml |
| T14 | Methoxyfenozide 21.8% SC-312.5 ml + Cyantraniliprole 10.26% OD-300 ml |
| T15 | Methoxyfenozide 21.8% SC-312.5 ml + Tetraniliprole 20% SC-150 ml |
| T16 | Methoxyfenozide 21.8% SC-312.5 ml + Cyclaniliprole 4.5% SL-600 ml |
| T17 | Methoxyfenozide 21.8% SC-312.5 ml + Flubendiamide 20% WG-150 g |
| T18 | Methoxyfenozide 21.8% SC-312.5 ml + Isocycloseram 10% DC-300 ml |
| T19 | Methoxyfenozide 21.8% SC-312.5 ml + Emamectin benzoate 5% SG-150 g (prior |
| | art) |
| T20 | Chlorantraniliprole 18.5% SC-150 ml |
| T21 | Cyantraniliprole 10.26% OD-300 ml |
| T22 | Tetraniliprole 20% SC-150 ml |
| T23 | Cyclaniliprole 4.5% SL-600 ml |
| T24 | Flubendiamide 20% WG-150 g |
| T25 | Isocycloseram 10% DC-300 ml |
| T26 | Emamectin benzoate 5% SG-150 g (prior art) |
| T27 | Methoxyfenozide 21.8% SC-312.5 ml |
| T28 | UTC (Untreated Check) |

TABLE 4
Residual control of DBM infesting cabbage crop

| | % DBM Larval control | | | | | | |
|---|---|---|---|---|---|---|---|
| | 3 DAT | | | | | | |
| Treatment | Observed | Calculated | Colby's | Synergism | 7 | 10 | 14 |
| Number | Value | Value | Ratio | (Y/N) | DAA | DAA | DAA |
| T1 | 100 | 94.38 | 1.06 | Y | 100 | 96.2 | 86.4 |
| T2 | 100 | 93.75 | 1.07 | Y | 100 | 95.4 | 82.8 |
| T3 | 100 | 93.38 | 1.07 | Y | 100 | 93.6 | 80.4 |
| T4 | 100 | 93.05 | 1.07 | Y | 100 | 94.2 | 81.2 |
| T5 | 100 | 93.42 | 1.07 | Y | 100 | 92.6 | 80.4 |
| T6 | 100 | 93.55 | 1.07 | Y | 100 | 91.6 | 80.0 |
| T7 | 85.0 | 85.74 | 0.99 | N | 84.0 | 77.2 | 60.2 |
| T8 | 82.8 | 84.13 | 0.98 | N | 83.2 | 74.2 | 57.8 |
| T9 | 82.4 | 83.20 | 0.99 | N | 82.2 | 72.6 | 56.2 |
| T10 | 81.2 | 82.36 | 0.99 | N | 81.6 | 71.8 | 57.2 |
| T11 | 81.6 | 83.29 | 0.98 | N | 83.2 | 70.4 | 55.4 |
| T12 | 80.6 | 83.63 | 0.96 | N | 81.0 | 72.8 | 54.8 |
| T13 | 84.4 | 86.68 | 0.97 | N | 81.8 | 70.8 | 58.6 |
| T14 | 83.8 | 85.19 | 0.98 | N | 80.6 | 69.4 | 55.2 |
| T15 | 82.2 | 84.32 | 0.97 | N | 79.6 | 69.2 | 54.4 |
| T16 | 81 | 83.53 | 0.97 | N | 78.6 | 68.8 | 55.2 |
| T17 | 82.6 | 84.40 | 0.98 | N | 79.2 | 68.2 | 53.8 |
| T18 | 83.2 | 84.71 | 0.98 | N | 78.4 | 69.4 | 52.4 |
| T19 | 82.4 | 83.37 | 0.99 | N | 82.6 | 68.6 | 51.6 |
| T20 | 66.2 | | | | 62.4 | 56.2 | 45.2 |
| T21 | 62.4 | | | | 59.4 | 51.8 | 40.2 |
| T22 | 60.2 | | | | 56.8 | 50.2 | 38.6 |
| T23 | 58.2 | | | | 55.2 | 48.8 | 40.2 |
| T24 | 60.4 | | | | 58.2 | 50.4 | 37.2 |
| T25 | 61.2 | | | | 57.4 | 49.2 | 36.6 |
| T26 | 57.8 | | | | 64.2 | 56.4 | 37.8 |
| T27 | 60.6 | | | | 58.2 | 49.2 | 35.4 |
| T28 | 0.0 | | | | 0.0 | 0.0 | 0.0 |

All the innovative ready-mix combinations (T1, T2, T3, T4, T5 and T6) provides synergistic control of DBM larvae and also provides excellent residual control up to 14 days after application (>80% larval control) in comparison to all prior art treatments (T7 to T19).

### Experiment 3: Control of Insect-Pests Infesting Brinjal, Solanum melongena Crop

Crop: Brinjal
Location: Padra, Gujarat
Plot size: 50 sq. mt.
Number of Treatments: 28
Application Time: As soon as fruit and shoot borer infestation observed (˜60 days after transplanting).
Method of Application: Foliar spray with knap sack sprayer
Water volume: 520 liter per hectare.
Agronomic Practices: All agronomic practices followed as per the crop requirement.
Observation Methods:

Fruit & Shoot borer (Leucinoides orbonalis) control (%)—Count the number of healthy and damaged shoots per plant. Record the observations from 10 plants per plot at 7 days after application (DAA). Calculate % shoot damage. Then recalculate % Fruit and shoot borer control.

$$Shoot damage ( \% ) by Fruit \& Shoot borer = \frac{Damaged shoots}{Total number of shoots observed} \times 100 \\ \% Fruit \& Shoot Borer ( FSB ) control = 100 - \frac{\% shoot damage by FSB in treated plot}{\% shoot damage by FSB in untreated plot} \times 100$$

Apply Colby's formula to % fruit and shoot borer control data to judge the synergism.

Whitefly (Bemisia tabaci) control (%):

Count the number of insects per leaf. Observed 3 leaves per plant and 10 plants per plot.

Calculate % insect (whitefly) control by given formula.

$$\% Insect control = 100 - \frac{Number of live insects in treatment}{Number of live insects in untreated} \times 100$$

% Insect control data used to check the synergism by applying Colby's formula given above.

Healthy fruits count: Count the number of healthy fruits per plant. Record the observations from 10 plants per plot and represent the data as average number of healthy fruits per plant at 15 days after spray.

TABLE 5
Treatment details for bio efficacy against insect-pests infesting brinjal crop

| Treatment | |
|---|---|
| Number | Treatment details with application Rate (ml or g per Hectare) |
| T1 | Methoxyfenozide 12% + Chlorantraniliprole 5% + Dimpropyridaz 4% SC-600 |
| | (ready-mix) |
| T2 | Methoxyfenozide 12% + Cyantraniliprole 8% + Dimpropyridaz 4% SC-600 ml |
| | (ready-mix) |
| T3 | Methoxyfenozide 12% + Tetraniliprole 8% + Dimpropyridaz 4% SC-600 ml (ready- |
| | mix) |
| T4 | Methoxyfenozide 12% + Broflanilide 2% + Dimpropyridaz 4% SC-600 ml (ready- |
| | mix) |
| T5 | Methoxyfenozide 12% + Fluxametamide 2% + Dimpropyridaz 4% SC-600 ml |
| | (ready-mix) |
| T6 | Methoxyfenozide 12% + Isocycloseram 2% + Dimpropyridaz 4% SC-600 ml (ready- |
| | mix) |
| T7 | Chlorantraniliprole 18.5% SC-150 ml + Dimpropyridaz 12% SC-200 ml (prior art) |
| T8 | Cyantraniliprole 10.26% OD-480 ml + Dimpropyridaz 12% SC-200 ml (prior art) |
| T9 | Tetraniliprole 20% SC-240 ml + Dimpropyridaz 12% SC-200 ml (prior art) |
| T10 | Broflanilide 30% SC-40 ml + Dimpropyridaz 12% SC-200 ml (prior art) |
| T11 | Fluxametamide 10% SC-120 ml + Dimpropyridaz 12% SC-200 ml (prior art) |
| T12 | Isocycloseram 10% DC-120 ml + Dimpropyridaz 12% SC-200 ml (prior art) |
| T13 | Methoxyfenozide 24% + Chlorantraniliprole 10% SC-300 (prior art) |
| T14 | Methoxyfenozide 12% + Cyantraniliprole 8% SC-600 ml (prior art) |
| T15 | Methoxyfenozide 12% + Tetraniliprole 8% SC-600 ml (prior art) |
| T16 | Methoxyfenozide 24% + Broflanilide 4% SC-300 ml (prior art) |
| T17 | Methoxyfenozide 24% + Fluxametamide 4% SC-300 ml (prior art) |
| T18 | Methoxyfenozide 24% + Isocycloseram 4% SC-300 ml (prior art) |
| T19 | Methoxyfenozide 21.8% SC-300 ml + Dimpropyridaz 12% SC-200 ml (prior art) |
| T20 | Chlorantraniliprole 18.5% SC-150 ml |
| T21 | Cyantraniliprole 10.26% OD-480 ml |
| T22 | Tetraniliprole 20% SC-240 ml |
| T23 | Broflanilide 30% SC-40 ml |
| T24 | Fluxametamide 10% SC-120 ml |
| T25 | Isocycloseram 10% DC-120 ml |
| T26 | Dimpropyridaz 12% SC-200 ml |
| T27 | Methoxyfenozide 21.8% SC-300 ml |
| T28 | UTC (Untreated Check) |

TABLE 6
Control of brinjal fruit and shoot borer, whitefly

| | % Whitefly control | | | % Fruit & Shoot borer control | | | | No. of |
|---|---|---|---|---|---|---|---|---|
| Treatment | Observed | Calculated | Colby's | Observed | Calculated | Colby's | Synergism | Healthy |
| Number | value | value | Ratio | value | value | Ratio | (Y/N) | fruits/plant |
| T1 | 90.4 | 70.93 | 1.27 | 98.8 | 90.45 | 1.09 | Y | 40.6 |
| T2 | 94.8 | 78.18 | 1.21 | 97.2 | 90.15 | 1.08 | Y | 42.8 |
| T3 | 88.8 | 72.24 | 1.23 | 96.4 | 90.24 | 1.07 | Y | 40.2 |
| T4 | 89.4 | 71.29 | 1.25 | 94.6 | 87.62 | 1.08 | Y | 41.2 |
| T5 | 86.4 | 77.37 | 1.12 | 97.2 | 91.41 | 1.06 | Y | 40.4 |
| T6 | 88.4 | 83.45 | 1.06 | 95.6 | 90.89 | 1.05 | Y | 42.2 |
| T7 | 65.2 | 66.81 | 0.98 | 82.0 | 82.83 | 0.99 | N | 36.4 |
| T8 | 74.4 | 75.09 | 0.99 | 81.2 | 82.28 | 0.99 | N | 38.6 |
| T9 | 67.2 | 68.32 | 0.98 | 80.6 | 82.44 | 0.98 | N | 38.2 |
| T10 | 66.4 | 67.23 | 0.99 | 75.8 | 77.73 | 0.98 | N | 36.6 |
| T11 | 72.4 | 74.17 | 0.98 | 82.4 | 84.56 | 0.97 | N | 34.8 |
| T12 | 80.2 | 81.11 | 0.99 | 81.2 | 83.61 | 0.97 | N | 38.6 |
| T13 | 28.6 | 30.45 | 0.94 | 74.2 | 75.65 | 0.98 | N | 33.2 |
| T14 | 46.6 | 47.79 | 0.98 | 72.4 | 74.87 | 0.97 | N | 35.2 |
| T15 | 32.6 | 33.60 | 0.97 | 73.4 | 75.09 | 0.98 | N | 35.2 |
| T16 | 30.2 | 31.32 | 0.96 | 66.8 | 68.42 | 0.98 | N | 33.8 |
| T17 | 43.8 | 45.86 | 0.96 | 75.8 | 78.09 | 0.97 | N | 32.6 |
| T18 | 58.6 | 60.40 | 0.97 | 74.4 | 76.76 | 0.97 | N | 31.8 |
| T19 | 60.2 | 63.38 | 0.95 | 76.2 | 78.20 | 0.97 | N | 32.2 |
| T20 | 20.6 | | | 56.2 | | | | 24.6 |
| T21 | 40.4 | | | 54.8 | | | | 27.8 |
| T22 | 24.2 | | | 55.2 | | | | 25.6 |
| T23 | 21.6 | | | 43.2 | | | | 23.6 |
| T24 | 38.2 | | | 60.6 | | | | 27.6 |
| T25 | 54.8 | | | 58.2 | | | | 28.2 |
| T26 | 58.2 | | | 60.8 | | | | 25.4 |
| T27 | 12.4 | | | 44.4 | | | | 22.8 |
| T28 | 0.0 | | | 0.0 | | | | 17.6 |

All the innovative ready-mix combinations (T1, T2, T3, T4, T5 and T6) provides synergistic control of fruit and shoot borer and whitefly. It also produces higher number of healthy fruits per plant in comparison to all prior art treatments (T7 to T19).

### Experiment 4: Control of Sucking Pests of Cotton

Crop: Cotton,
Location: Baroda, Gujarat
Treatments: 28
Plot size: 30 sq.m
Spacing: 120 cm×60 cm
Time of Application: As soon as sucking pests reached 5-10 insects per leaf
Method of Application: Foliar spray with knapsack sprayer
Water volume: 400 liter/hectare
Agronomic Practices: All agronomic practices followed as per the crop requirement.
Observation Methods:
Sucking pests (Jassid, Amrasca biguttula biguttula) control (%):
Count the number of insects per leaf. Observed 3 leaves per plant and 5 plants per plot. Calculate % insect (jassid) control by given formula.

$$\% Insect control = 100 - \frac{Number of live insects in treatment}{Number of live insects in untreated} \times 100$$

% Insect control data used to check the synergism by applying Colby's formula given above.
Spodoptera larval control (%): Count the number of live larvae per plant. Observed such 10 plants per plot and calculate % larval control.
Fruiting bodies count: Count the number of fruiting bodies (square, flowers and balls) per plant.

Record the observations from 10 plants per plot at 15 days after spray.

TABLE 7
Treatment details for field bio efficacy against insect-pests infesting cotton

| Treatment | |
|---|---|
| Number | Treatment details with application Rate (ml or g per Hectare) |
| T1 | Methoxyfenozide 15% + Chlorantraniliprole 5% + Clothianidin 8% SC-500 (ready- |
| | mix) |
| T2 | Methoxyfenozide 15% + Cyantraniliprole 10% + Clothianidin 8% SC-500 ml (ready- |
| | mix) |
| T3 | Methoxyfenozide 15% + Tetraniliprole 10% + Clothianidin 8% SC-500 ml (ready- |
| | mix) |
| T4 | Methoxyfenozide 15% + Broflanilide 2% + Clothianidin 8% SC-500 ml (ready-mix) |
| T5 | Methoxyfenozide 15% + Fluxametamide 2% + Clothianidin 8% SC-500 ml (ready- |
| | mix) |
| T6 | Methoxyfenozide 15% + Isocycloseram 2% + Clothianidin 8% SC-500 ml (ready-mix) |
| T7 | Chlorantraniliprole 18.5% SC-125 ml + Clothianidin 50% WG-80 g (prior art) |
| T8 | Cyantraniliprole 10.26% OD-500 ml + Clothianidin 50% WG-80 g (prior art) |
| T9 | Tetraniliprole 20% SC-250 ml + Clothianidin 50% WG-80 g (prior art) |
| T10 | Broflanilide 30% SC-33.33 ml + Clothianidin 50% WG-80 g (prior art) |
| T11 | Fluxametamide 10% SC-100 ml + Clothianidin 50% WG-80 g (prior art) |
| T12 | Isocycloseram 10% DC-100 ml + Clothianidin 50% WG-80 g (prior art) |
| T13 | Methoxyfenozide 21.8% SC-312.5 ml + Chlorantraniliprole 18.5% SC-125 ml (prior |
| | art) |
| T14 | Methoxyfenozide 21.8% SC-312.5 ml + Cyantraniliprole 10.26% OD-500 ml (prior |
| | art) |
| T15 | Methoxyfenozide 21.8% SC-312.5 ml + Tetraniliprole 20% SC-250 ml (prior art) |
| T16 | Methoxyfenozide 21.8% SC-312.5 ml + Broflanilide 30% SC-33.33 ml (prior art) |
| T17 | Methoxyfenozide 21.8% SC-312.5 ml + Fluxametamide 10% SC-100 ml (prior art) |
| T18 | Methoxyfenozide 21.8% SC-312.5 ml + Isocycloseram 10% DC-100 ml (prior art) |
| T19 | Methoxyfenozide 21.8% SC-312.5 ml + Clothianidin 50% WG-80 g (prior art) |
| T20 | Chlorantraniliprole 18.5% SC-125 ml |
| T21 | Cyantraniliprole 10.26% OD-500 ml |
| T22 | Tetraniliprole 20% SC-250 ml |
| T23 | Broflanilide 30% SC-33.33 ml |
| T24 | Fluxametamide 10% SC-100 ml |
| T25 | Isocycloseram 10% DC-100 ml |
| T26 | Clothianidin 50% WG-80 g (prior art) |
| T27 | Methoxyfenozide 21.8% SC-312.5 ml |
| T28 | UTC (Untreated Check) |

TABLE 8
Control of Spodoptera and Jassid infesting cotton crop

| | | | | | | | | No. of |
|---|---|---|---|---|---|---|---|---|
| | % Jassid control | | | % Spodoptera larval control | | | | Fruiting |
| Treatment | Observed | Calculated | Colby's | Observed | Calculated | Colby's | Synergism | bodies/ |
| Number | Value | value | Ratio | Value | value | Ratio | (Y/N) | plant |
| T1 | 73.6 | 68.09 | 1.08 | 91.4 | 79.03 | 1.16 | Y | 78.6 |
| T2 | 78.6 | 69.43 | 1.13 | 92.4 | 81.54 | 1.13 | Y | 79.4 |
| T3 | 73.4 | 68.46 | 1.07 | 93.6 | 80.70 | 1.16 | Y | 76.4 |
| T4 | 89.6 | 81.46 | 1.10 | 94.2 | 79.68 | 1.18 | Y | 75.2 |
| T5 | 92.6 | 82.88 | 1.12 | 91.8 | 82.00 | 1.12 | Y | 74.8 |
| T6 | 80.6 | 71.90 | 1.12 | 92.2 | 81.63 | 1.13 | Y | 75.6 |
| T7 | 63.2 | 64.30 | 0.98 | 60.2 | 60.59 | 0.99 | N | 63.4 |
| T8 | 64.4 | 65.81 | 0.98 | 64.6 | 65.29 | 0.99 | N | 64.2 |
| T9 | 63.0 | 64.72 | 0.97 | 61.2 | 63.72 | 0.96 | N | 61.4 |
| T10 | 77.8 | 79.27 | 0.98 | 60.6 | 61.81 | 0.98 | N | 62.4 |
| T11 | 77.8 | 80.86 | 0.96 | 65.4 | 66.17 | 0.99 | N | 59.8 |
| T12 | 66.4 | 68.57 | 0.97 | 64.2 | 65.47 | 0.98 | N | 65.2 |
| T13 | 22.2 | 23.65 | 0.94 | 74.4 | 75.95 | 0.98 | N | 68.8 |
| T14 | 24.8 | 26.87 | 0.92 | 77.2 | 78.83 | 0.98 | N | 67.4 |
| T15 | 23.2 | 24.55 | 0.95 | 75.4 | 77.87 | 0.97 | N | 64.2 |
| T16 | 54.4 | 55.66 | 0.98 | 73.8 | 76.70 | 0.96 | N | 66.8 |
| T17 | 57.6 | 59.05 | 0.98 | 77.8 | 79.36 | 0.98 | N | 67.2 |
| T18 | 30.4 | 32.77 | 0.93 | 76.4 | 78.93 | 0.97 | N | 64.2 |
| T19 | 61.4 | 62.63 | 0.98 | 52.4 | 53.61 | 0.98 | N | 60.2 |
| T20 | 14.6 | | | 54.8 | | | | 51.4 |
| T21 | 18.2 | | | 60.2 | | | | 56.2 |
| T22 | 15.6 | | | 58.4 | | | | 50.6 |
| T23 | 50.4 | | | 56.2 | | | | 54.8 |
| T24 | 54.2 | | | 61.2 | | | | 53.2 |
| T25 | 24.8 | | | 60.4 | | | | 48.6 |
| T26 | 58.2 | | | 12.8 | | | | 47.2 |
| T27 | 10.6 | | | 46.8 | | | | 44.6 |
| T28 | 0.0 | | | 0.0 | | | | 36.6 |

All the innovative ready-mix combinations (T1, T2, T3, T4, T5 and T6) shows synergism in terms of efficacy against jassid and spodoptera larval control and also produces higher number of fruiting bodies compared to all prior art treatments (T7 to T19).

### Overall Summary of Field Trials

The field trials results shows many benefits/advantages of ready mix formulations of methoxyfenozide+diamide insecticide+one more insecticide.
Synergism observed in terms of insect control
Provides higher level of insect control (increase % control)
Provides longer duration of control (residual control)
Provides effective control of a greater number of insect-pests species at a time and over a period of time. Example sucking insect (jassid) and chewing insects (spodoptera)
Increases plant growth, vigor, height, produces a greater number of tillers, shoots, branches, flowers, fruits, pods, square, bolls, seeds, grains etc. and overall biomass of the crop, which directly increases the yield of the crop.
Increase in bio efficacy and residual control also observed due to novel and innovative recipe of formulations (ZC and SC).

Product used in bio-efficacy trials are Chlorantraniliprole 18.5% w/w SC (20% w/v), Cyantraniliprole 10.26% w/w OD (10% w/v), Cyclaniliprole 4.5% w/w SL (5% w/v), Methoxyfenozide 21.8% w/w SC (24% w/v).

Terminology used in bio-efficacy trials are cm-centimetre, m-meter, g-gram, kg-kilogram, ml-millilitre, sq.mt. square meter (m²), DAS Days after sowing, DAP Days after planting, DATP Days after transplanting, DAA Days after application, T for Treatment, spp.-species, Ob. Value-observed value, Cal.Value-calculated value.

We claim:

1) An insecticidal composition for pest control comprising:
a) an insecticide from diacylhydrazines group present in amount of 1% -30% by weight;
b) an insecticide from diamide or pyridylpyrazole group present in amount of 1%-20% by weight;
c) an insecticide selected from group of different insecticides present in amount of 0.5% -50% by weight;
d) an inactive formulation excipients.

2) The insecticidal composition as claimed in claim 1, wherein a composition for pest control comprises:
a) an insecticide from diacylhydrazines group is selected from Chromafenozide, Halofenozide, methoxyfenozide, tebufenozide;
b) an insecticide from diamide or pyridylpyrazole group is selected from chlorantraniliprole, cyantraniliprole, cyclaniliprole, cyhalodiamide, cyproflanilide, flubendiamide, tetraniliprole, tetrachlorantraniliprole, broflanilide, fluxametamide and isocycloseram.
c) an insecticide selected from group of different insecticides is selected from the group consisting of an acetylcholine esterase inhibitors from the class of carbamates, acetylcholine esterase inhibitors from the class of organophosphates, cyclodiene organochlorine compounds, fiproles, sodium channel modulators from the class of pyrethroids, nicotinic acteylcholine receptor agonists from the class of neonicotinoids, allosteric nicotinic acteylcholine receptor activators from the class of spinosyns, chloride channel activators from the class of mectins, juvenile hormone mimics, non-specific multi-site inhibitors, selective homopteran feeding blockers, mite growth inhibitors, microbial disruptors of insect midgut membrane, inhibitors of mitochondrial ATP synthase, uncouplers of oxidative phosphorylation, nicotinic acetylcholine receptor channel blockers, inhibitors of the chitin biosynthesis affecting CHS1, inhibitors of the chitin biosynthesis type 1, moulting disruptors, Octopamin receptor agonists, Mitochondrial complex III electron transport inhibitors, Mitochondrial complex I electron transport inhibitors, Voltage-dependent sodium channel blockers, Inhibitors of the lipid synthesis, inhibitors of acetyl CoA carboxylase, Mitochondrial complex II electron transport inhibitors, chlorodontal organ modulators, Baculoviruses, Compounds of unknown or uncertain mode of action.

3) The insecticidal composition as claimed in claim 2, wherein an insecticide from
Acetylcholine esterase inhibitors from the class of carbamates is selected from aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, and triazamate;
Acetylcholine esterase inhibitors from the class of organophosphates is selected from acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion;
GABA-gated chloride channel antagonists from cyclodiene organochlorine compounds is selected from endosulfan; or Phenylpyrazole (fiproles) is selected from ethiprole, fipronil, flufiprole, nicofluprole, pyrafluprole, or pyriprole; Sodium channel modulators from the class of pyrethroids is selected from acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, meperfluthrin, metofluthrin, momfluorothrin, permethrin, phenothrin, prallethrin, profluthrin, pyrethrin (py rethrum), resmethrin, silafluofen, tefluthrin, tetramethylfluthrin, tetramethrin, tralomethrin, transfluthrin;
Nicotinic acteylcholine receptor (nAChR) competitive modulators is selected from Neonicotinoids like acetamiprid, clothianidin, dinotefuran, imidacloprid, nitenpyram, thiacloprid, thiamethoxam; or Sulfoximines like sulfoxaflor; or Butenolides like flupyradifurone; or Mesoionics like triflumezopyrim and flupyrimin;
Nicotinic acteylcholine receptor (nAChR) allosteric modulators-Site I-from the class of spinosyns is selected from spinosad, spinetoram.
Glutamate-gated Chloride channel (GluCl) allosteric modulators-class of mectins is selected from Avermectins like abamectin, emamectin benzoate, ivermectin, lepimectin; Milbemycins like milbemectin;
Juvenile hormone mimics is selected from hydroprene, kinoprene, methoprene, fenoxycarb, pyriproxyfen;
Chordotonal organ TRPV channel modulators-selective homopteran feeding blockers is selected from pyridine azomethine like pymetrozine, pyrifluquinazon; pyropenes like afidopyropen;
mite growth inhibitors affecting CHS1 is selected from clofentezine, hexythiazox, diflovidazin or etoxazole;
Microbial disruptors of insect midgut membrane is selected from Bacillus thuringiensis and insecticidal proteins they product;
Inhibitors of mitochondrial ATP synthase is selected from diafenthiuron, azocyclotin, cyhexatin, fenbutatin oxide, propargite, or tetradifon;
Uncouplers of oxidative phosphorylation is selected from chlorfenapyr, DNOC, or sulfluramid;
Inhibitors of the chitin biosynthesis affecting CHS1 is selected from Benzoylureas-bistrifluron, chlorfluazuron, diflubenzuron, flucycloxuron, flufenoxuron, hexaflumuron, lufenuron, novaluron, noviflumuron, teflubenzuron, and triflumuron;
Inhibitors of the chitin biosynthesis type 1 is selected from buprofezin;
Moulting disruptors is selected from cyromazine;
Octopamin receptor agonists is selected from amitraz;
Mitochondrial complex III electron transport inhibitors is selected from hydramethylnon, acequinocyl, flometoquin, fluacrypyrim, pyriminostrobin or bifenazate;
Mitochondrial complex I electron transport inhibitors is selected from fenazaquin, fenpyroximate, pyrimidifen, pyridaben, tebufenpyrad, tolfenpyrad, flufenerim, or rotenone;
Voltage-dependent sodium channel blockers is selected from oxadiazines like indoxacarb; semicarbazones like metaflumizone; or or 1-[(E)-[2-(4-cyanophenyl)-1-[3-(trifluoromethyl) phenyl]ethylidene] amino]-3-[4 (difluoromethoxy) phenyl] urea.
Inhibitors of the lipid synthesis, inhibitors of acetyl CoA carboxylase is selected from Tetronic and tetramic acid derivatives like spirodiclofen, spiromesifen, spirotetramat or spiropidion;
Mitochondrial complex II electron transport inhibitors is selected from cyenopyrafen, cyflumetofen or pyflubumide;
Chordotonal organ modulators is selected from unidentified-flonicamid;
Baculoviruses is selected from Granuloviruses and Nucleopolyhedrosis viruses;
An unclassified Compound with uncertain mode of action is selected from azadirechtin, benzoximate, pyridalyl, benzpyrimoxan, oxazosulfyl (ethyl 2-{5-[trifluoromethyl)sulfonyl]-1,3-benzoxazol-2-yl}-3-pyridyl sulfone); dimpropyridaz (1-[(1RS)-1,2-dimethylpropyl]-N-ethyl-5-methyl-N-pyridazin-4-yl-1H-pyrazole-4-carboxamide), isoxazoline insecticide-tyclopyrazoflor (N-[3-chloro-1-(3-pyridyl)-1H-pyrazol-4-yl]-N-ethyl-3-[(3,3,3-trifluoropropyl)thio] pro-penamide); fluhexafon.

4) The insecticidal composition as claimed in claim 1, wherein a formulation for the said composition is selected from Capsule suspension (CS), Dispersible concentrate (DC), Powder for dry seed treatment (DS), Emulsifiable concentrate (EC), Emulsion, water in oil (EO), Emulsion for seed treatment (ES), Emulsion, oil in water (EW), Flowable suspension/concentrate for seed treatment (FS), Granule/ soil applied (GR), Controlled (Slow or Fast) release granules (CR), Solution for seed treatment (LS), Micro-emulsion (ME), Oil dispersion (OD), Oil miscible flowable concentrate (oil miscible suspension (OF), Oil miscible liquid (OL), Suspension concentrate (flowable concentrate) (SC), Suspo-emulsion (SE), Water soluble granule (SG), Soluble concentrate (SL), Water soluble powder (SP), Water dispersible granule (WG or WDG), Wettable powder (WP), Water dispersible powder for slurry treatment (WS), A mixed formulation of CS and SC (ZC), A mixed formulation of CS and SE (ZE), A mixed formulation of CS and EW (ZW).

5) The insecticidal composition as claimed in claim 1, wherein the preferred combinations of active ingredients in the composition of the Suspension Concentrate (SC) formulation comprises:
i. Methoxyfenozide 12%+Chlorantraniliprole 5%+Dimpropyridaz 4%;
ii. Methoxyfenozide 12%+Cyantraniliprole 8%+Dimpropyridaz 4%;
iii. Methoxyfenozide 12%+Tetraniliprole 8%+Dimpropyridaz 4%;
iv. Methoxyfenozide 12%+Broflanilide 2%+Dimpropyridaz 4%;
v. Methoxyfenozide 12%+Fluxametamide 2%+Dimpropyridaz 4%;
vi. Methoxyfenozide 12%+Isocycloseram 2%+Dimpropyridaz 4%;
vii. Methoxyfenozide 15%+Chlorantraniliprole 5%+Clothianidin 8%;
viii. Methoxyfenozide 15%+Cyantraniliprole 10%+Clothianidin 8%;
ix. Methoxyfenozide 15%+Tetraniliprole 10%+Clothianidin 8%;
x. Methoxyfenozide 15%+Broflanilide 2%+Clothianidin 8%;
xi. Methoxyfenozide 15%+Fluxametamide 2%+Clothianidin 8%;
xii. Methoxyfenozide 15%+Isocycloseram 2%+Clothianidin 8%.

6) The insecticidal composition as claimed in claim 5, wherein the Suspension Concentrate (SC) formulation comprises:
a) an insecticide from diacylhydrazines group is present in amount of 1% -30% by weight of the composition is Methoxyfenozide;
b) an insecticide from diamide or pyridyl pyrazole group present in amount of 1% -20% by weight of the composition is selected from Chlorantraniliprole, Cyantraniliprole, Tetraniliprole, Broflanilide, Fluxametamide, Isocycloseram;
c) an insecticide selected from group of different insecticides present in amount of 0.5%-50% by weight of the composition is selected from Dimpropyridaz, Clothianidin;
d) Wetting-spreading-penetrating agent in an amount of 2 to 6% by weight;
e) Dispersing agent 1 in an amount of 2 to 8% by weight;
f) Dispersing agent 2 in an amount of 1 to 5% by weight;
g) Suspending agent in an amount of 0.2 to 4.0% by weight;
h) Antifoaming agent in an amount of 0.1 to 1.5% by weight;
i) Preservative in an amount of 0.1 to 0.5% by weight;
j) Antifreezing agent in an amount of 2 to 6% by weight;
k) Thickener in an amount of 0.1 to 1.0% by weight;
l) Diluent Water in an amount of 40 to 70% by weight.

7) The insecticidal composition as claimed in claim 5, wherein Wetting-spreading-penetrating agent is selected from Organo silicone surfactants includes trisiloxane ethoxylate, polydimethylsiloxane, polyoxyethylene methyl polysiloxane, polyoxyalkylene methyl polysiloxane, polyether polymethyl siloxane copolymer, modified heptamethyl trisiloxane, polyether modified polysiloxane, 10 mole ethylene oxide adduct of octylphenol, may or may not be in modified form, may be liquid or powder form or mixture thereof.

8) The insecticidal composition as claimed in claim 5, wherein dispersing agent is selected from alkylated naphthalene sulfonate, sodium salt, sodium salt of naphthalene sulfonate condensate, sodium ligno sulfonate, sodium ploycarboxylate, EO/PO based copolymer, phenol sulfonate, sodium methyl oleoyl taurate, styrene acrylic acid copolymer, propylene oxide-ethylene oxide-copolymer, polyethylene glycol 2,4,6-tristyrylphenyl ether, tristyryl phenol-polyglycol ether-phosphate, tristyryl phenole with 16 moles EO, tristyryl phenol-polyglycol ether-phosphate, oleyl-polyglycol ether with ethylene oxide, tallow fatty amine polyethylene oxide, nonylphenol polyglycol ether with 9-10 moles ethylene oxide.

9) The insecticidal composition as claimed in claim 5, wherein suspending agent is selected from aluminum magnesium silicate, bentonite clay, silica, attapulgite clay.

10) The insecticidal composition as claimed in claim 5, wherein anti-freezing agent is selected from ethylene glycol, propane diols, glycerine or the urea, glycol (monoethylene glycol, diethylene glycol, polypropylene glycol, polyethylene glycol), glycerine, urea, magnesium sulfate heptahydrate, sodium chloride.

11) The insecticidal composition as claimed in claim 1, wherein the preferred combinations of active ingredients in the composition of the ZC formulation comprises:
i. Methoxyfenozide 9%+Chlorantraniliprole 2%+Lambda Cyhalothrin 1%;
ii. Methoxyfenozide 9%+Cyantraniliprole 5%+Lambda Cyhalothrin 1%;
iii. Methoxyfenozide 9%+Tetraniliprole 5%+Lambda Cyhalothrin 1%;
iv. Methoxyfenozide 9%+Cyclaniliprole 5%+Lambda Cyhalothrin 1%;
v. Methoxyfenozide 9%+Flubendiamide 2%+Lambda Cyhalothrin 1%;
vi. Methoxyfenozide 9%+Isocycloseram 5%+Lambda Cyhalothrin 1%;
vii. Methoxyfenozide 15%+Chlorantraniliprole 6%+Emamectin benzoate 1.5%;
viii. Methoxyfenozide 15%+Cyantraniliprole 6%+Emamectin benzoate 1.5%;
ix. Methoxyfenozide 15%+Tetraniliprole 6%+Emamectin benzoate 1.5%;
x. Methoxyfenozide 15%+Cyclaniliprole 6%+Emamectin benzoate 1.5%;
xi. Methoxyfenozide 15%+Flubendiamide 6%+Emamectin benzoate 1.5%;
xii. Methoxyfenozide 15%+Isocycloseram 6%+Emamectin benzoate 1.5%.

12) The insecticidal composition as claimed in claim 11, wherein (ZC) formulation comprises:
a) an insecticide from diacylhydrazines group is present in amount of 1%-30% by weight of the composition is Methoxyfenozide;
b) an insecticide from diamide or pyridyl pyrazole group present in amount of 1%-20% by weight of the composition is selected from Chlorantraniliprole, Cyantraniliprole, Tetraniliprole, Broflanilide, Fluxametamide, Isocycloseram;
c) an insecticide selected from group of different insecticides present in amount of 0.5%-50% by weight of the composition is selected from Lambda Cyhalothrin, Emamectin benzoate;
d) Wetting-spreading-penetrating agent in an amount of 2 to 6% by weight;
e) Dispersing agent 1 in an amount of 2 to 8% by weight;
f) Dispersing agent 2 in an amount of 1 to 3% by weight;
g) Solvent in an amount of 6 to 10% by weight;
h) Wall forming material 1 in an amount of 0.1 to 3% by weight;
i) Wall forming material 2 in an amount of 0.1 to 2% by weight;
j) Suspending agent in an amount of 1 to 3% by weight;
k) Antifoaming agent in an amount of 0.1 to 1.0% by weight;
l) Buffering agent in an amount of 0.1 to 2.0% by weight;
m) Preservative in an amount of 0.05 to 1.0% by weight;
n) Antifreezing agent in an amount of 4 to 8% by weight;
o) Thickener in an amount of 0.05 to 2.0% by weight;
p) Diluent Water in an amount of 40 to 70% by weight.

13) The insecticidal composition as claimed in 12, wherein suspending agent is selected from Aluminum Magnesium Silicate, Bentonite clay, Silica, Attapulgite clay.

14) The insecticidal composition as claimed in 12, wherein, Wetting-spreading-penetrating agent is selected from Organo silicone surfactants includes trisiloxane ethoxylate, polydimethylsiloxane, polyoxyethylene methyl polysiloxane, polyoxyalkylene methyl polysiloxane, polyether polymethyl siloxane copolymer, modified heptamethyl trisiloxane, polyether modified polysiloxane, 10 mole ethylene oxide adduct of octylphenol, may or may not be in modified form, may be liquid or powder form or mixture thereof.

15) The insecticidal composition as claimed in 12, wherein wall forming agent is selected from Tetramethylene diisocyanate, pentamethylene diisocyanate, hexamethylene diisocyanate, toluene diisocyanate, diphenylmethene-4,4′-diisocyanate, polymethylene polyphenylene isocyanate, 2,4,4′-diphenyl ether tri-isocyanate, 3,3′-dimethyl-4,4′-diphenyl diisocyanate, 3,3′-dimethoxy-4,4′-diphenyl diisocyanate, 1,5-naphthylene diisocyanate and 4,4′4″-triphenylmethane tri-isocyanate, toluene diisocyanate or polymethylene polyphenylisocyanate; Ammonia, hexamine, ethylenediamine, propylene-1,3-diamine, tetramethylenediamine, pentamethylene diamine, 1,6-hexamethylenediamine, diethylenetriamine, triethylene-tetramine, tetra ethylene pentamine, pentaethylenehex amine, 4,9-dioxadodecane-1,12-diamine, 1,3-phenylene diamine, 2,4- and 2,6-toluenediamine and 4,4′-diaminodiphenylmethane, 1,3-phenylenediamine, 2,4- and 2,6-toluenediamine, 4,4′-diaminodiphenylmethane, 1,5-diaminonaphthalene, 1,3,5-triaminobenzene, 2,4,6-triaminotoluene, 1,3,6-triaminonaphthalene, 2,4,4′-triaminodiphenyl ether, 3,4,5-triamino-1,2,4-triazole and 1,4,5,8-tetraminoanthraquinone.

16) The insecticidal composition as claimed in claim 12, wherein anti-foaming agent is selected from silicone oil, silicone compound, C10˜C20 saturated fat acid compounds or C8˜-C10 aliphatic alcohols compound, Silicone antifoam emulsion, Dimethyl siloxane, Polydimethyl siloxane, Vegetable oil based antifoam, tallow based fatty acids, polyalkyleneoxide modified polydimethylsiloxane.

17) The insecticidal composition as claimed in claim 12, wherein preservative is selected from 1,2-benzisothiazolin-3(2H)-one, sodium salt, sodium benzoate, 2-bromo-2-nitropropane-1,3-diol, formaldehyde, sodium o-phenylphenate, 5-chloro-2-methyl-4-isothiazolin-3-one & 2-methyl-4-isothiazolin-3-one.
